(19) United States
(12) Patent Application Publication
(10) Pub. No.: US 2016/0071374 A1
(43) Pub. Date: Mar. 10, 2016

(54) GAMING MACHINE AWARDING PLURAL TYPES OF PROGRESSIVE PAYOUTS WHICH ARE DIFFERENT IN PAYOUT AMOUNTS AND IN EACH OF WHICH PART OF BET AMOUNT IS ACCUMULATED EACH TIME UNIT GAME IS EXECUTED

(71) Applicants: Universal Entertainment Corporation, Tokyo (JP); Aruze Gaming America, Inc., Las Vegas, NV (US)

(72) Inventors: Kenta KITAMURA, Tokyo (JP); Kenji ENOKIDO, Tokyo (JP); Tetsuya TERANISHI, Tokyo (JP); Takaki NARITA, Tokyo (JP)

(73) Assignees: Universal Entertainment Corporation; Aruze Gaming America, Inc.

(21) Appl. No.: 14/849,969

(22) Filed: Sep. 10, 2015

(30) Foreign Application Priority Data
Sep. 10, 2014 (JP) 2014-184646

(51) Int. Cl. G07F 17/32; G07F 17/34

(52) U.S. Cl. CPC G07F 17/3258; G07F 17/34

(57) ABSTRACT

A gaming machine, which is configured to award, as a prize, one of plural types of progressive payouts which are different from one another in payout amount and are formed by accumulating a part of a bet amount each time a unit game is executed, includes a display device and a controller. The controller executes the processes of: (A) executing a normal game in which the symbols are rearranged on the display device and a prize is awarded in accordance with a combination of the rearranged symbols; (B) randomly selecting one of the plural types of progressive payouts; and (C) after the number of the specific symbol stored in association with the progressive payout selected in the process (B) is displayed stepwise on the display device, executing the selected progressive payout.

### CROSS REFERENCE TO RELATED APPLICATION

The present application claims priority from Japanese Patent Application No. 2014-184646, which was filed on Sep. 10, 2014, the disclosure of which is incorporated herein by reference in its entirety.

### BACKGROUND OF THE INVENTION

1. Field of the Invention

The present invention relates to a gaming machine which is configured to award progressive payouts of different types which are different in payout amounts and in each of which a part of a bet amount is accumulated each time a unit game is executed.

2. Description of Related Art

There are known gaming machines each configured to award a progressive payout (progressive jackpot) (e.g., U.S. Patent Publication No1.2011/0118003). A progressive payout is arranged such that, a part of a bet amount bet in a gaming machine is accumulated, and the accumulated credits are awarded when a trigger is established. Among these gaming machines, there is a gaming machine which is configured to award plural types of progressive payouts which are different in payout amounts.

### SUMMARY OF THE INVENTION

In the gaming machine configured to award plural types of progressive payouts, an effect of indicating which type of the progressive payout is to be awarded plays an important role in the improvement in entertainment characteristics of the gaming machine. However, providing, for example, an additional effect device in the gaming machine for the effect is disadvantageous in terms of cost.

An object of the present invention is therefore to provide a gaming machine which achieves, with a simple arrangement, an effect indicating which one of plural types of progressive payouts is to be awarded.

The present invention relates to a gaming machine configured to award, as a prize, one of plural types of progressive payouts which are different from one another in payout amount and are formed by accumulating a part of a bet amount each time a unit game is executed, the gaming machine including:
a display device in which symbols are rearranged on reels on which the symbols including a specific symbol are lined up; and
a controller which is configured to select one of the plural types of the progressive payouts based on processes (A) to (C),
the controller being programmed to execute the processes of:
(A) executing a normal game in which the symbols are rearranged on the display device and a prize is awarded in accordance with a combination of the rearranged symbols;
(B) when the prize awarded in the normal game is a right to award one of the plural types of the progressive payouts, randomly selecting one of the plural types of progressive payouts; and
(C) after the number of the specific symbol stored in association with the progressive payout selected in the process (B) is displayed stepwise on the display device, executing the selected progressive payout.

With the arrangement above, an effect indicating which one of the plural types of progressive payouts is awarded as a prize is performed by displaying the specific symbols stepwise on the display device. In this way, as the symbols on the display device displaying a game result in the normal game are used for the effect indicating which one of the plural types of progressive payouts is awarded as a prize, the effect is performed with a simple arrangement.

In addition to the above, the present invention relates to a gaming machine configured to award, as a prize, one of plural types of progressive payouts which are different from one another in payout amount and are formed by accumulating a part of a bet amount each time a unit game is executed, the gaming machine including:
a display device in which symbols are rearranged on reels on which the symbols including a specific symbol are lined up;
a storage configured to store: a first table in which a total number of plural types of the specific symbol rearrangeable stepwise on the display device when a winning condition of obtaining one of the plural types of progressive payouts is established is associated with each of the plural types of progressive payouts; and a second table in which, for each total number of the plural types of of the specific symbol rearrangeable stepwise on the display device when the winning condition is established, a predetermined number of allocation patterns each defining the number of the specific symbol allocated to each step are provided; and
a controller programmed to execute the processes of:
(a1) executing a normal game in which the symbols are rearranged on the display device and a prize is awarded in accordance with a combination of the rearranged symbols;
(a2) when the winning condition is established in the normal game, randomly determining the total number of the specific symbol to be rearranged stepwise on the display device;
(a3) randomly selecting one of the predetermined number of the allocation patterns associated in the second table with the total number of the specific symbol determined in the process (a2), and determining the number of the specific symbol allocated to each step;
(a4) in each step, rearranging the specific symbol on the display device, the number of the specific symbol being determined in the process (a3); and
(a5) awarding, as a prize, the progressive payout which is associated in the first table with the total number of the specific symbol determined in the process (a2).

With the arrangement above, an effect indicating which one of the plural types of progressive payouts is awarded as a prize is performed by displaying the specific symbols stepwise on the display device. In this way, as the symbols on the display device displaying a game result in the normal game are used for the effect indicating which one of the plural types of progressive payouts is awarded as a prize, the effect is performed with a simple arrangement. Furthermore, the number of the specific symbols allocated to each step is determined by an allocation pattern which is randomly selected from the predetermined number of the allocation patterns. This diversifies the rearrangement patterns of the specific symbols rearranged in the display device in each step, and hence effect patterns of the effect of indicating which one of the plural types of progressive payouts is awarded as a prize are diversified.

In addition to the above, the gaming machine of the present invention is arranged such that the storage is configured to further store a third table in which, for each number of the plural types of of the specific symbol rearrangeable on the display device in each step, a predetermined number of allocation patterns each defining the number of the specific symbol allocated to each of the reels displayed on the display device are provided, and
the controller is programmed to further execute the processes of:
(b) randomly selecting, in each step, one of the predetermined number of the allocation patterns associated in the third table with the number of the specific symbol determined in the process (a3), and determining the number of the specific symbol allocated to each of the reels displayed on the display device in each step; and
in the process (a4),
rearranging the specific symbol on each of the reels displayed on the display device in each step, the number of the specific symbol being determined in the process (b).

According to the arrangement above, the number of the specific symbols allocated to each of the reels in each step is determined based on the allocation pattern randomly selected from the predetermined number of the allocation patterns. This diversifies the rearrangement patterns of the specific symbols rearranged on the display device in each step, and hence the effect patterns of the effect of indicating which one of the plural types of progressive payouts is awarded as a prize are further diversified.

The gaming machine of the present invention is arranged such that the storage is configured to further store a fourth table which defines, for each bet amount bettable on the unit game, a selection rate at which each total number of the plural types of the specific symbol rearrangeable stepwise on the display device when the winning condition is established is selected in the process (a2),
the fourth table defines that, as the bet amount bet on the unit game increases, the selection rate of the number of the specific symbol associated in the first table with the progressive payout with a large payout increases,
the controller is programmed to further execute, in the process (a2), the process of randomly determining the total number of the specific symbol based on the selection rate of each number of the plural types of the specific symbol associated in the fourth table with the bet amount bet on the unit game.

With the arrangement above, the larger the bet amount bet on the unit game is, the higher the probability of winning the progressive payout with a large payout is. As a result, when the winning condition is established while the bet amount bet on the normal game is large, the player expects a winning of the progressive payout with a large payout.

In addition to the above, the gaming machine of the present invention is arranged such that, the controller is programmed to further execute the processes of:
(c1) when a predetermined condition is established in the normal game, determining whether to award, as a prize, a right of shifting from the normal game to a special game;
(c2) when it is determined in the process (c1) that the right of shifting to the special game is awarded, executing a game of rearranging the symbols on the display device for a predetermined number of times, and awarding a prize in accordance with a combination of the symbols rearranged on the display device; and
(c3) when it is determined in the process (c1) that the right of shifting to the special game is not awarded, establishing the winning condition.

With this arrangement, a prize awarded at the time of the establishment of the predetermined condition in the normal game is diversified.

In the present invention, an effect indicating which one of plural types of progressive payouts is to be awarded is achieved with a simple arrangement.

### BRIEF DESCRIPTION OF THE DRAWINGS

Other and further objects, features and advantages of the invention will appear more fully from the following description taken in connection with the accompanying drawings in which:

FIG. 1 illustrates an operation state of a gaming machine.

FIG. 2 is a functional flow of the gaming machine related to the present invention.

FIG. 3 is a perspective view of a slot machine which is the gaming machine.

FIG. 4 illustrates symbol columns.

FIG. 5 is an electrical block diagram of the gaming machine.

FIG. 6 illustrates a normal game symbol table.

FIG. 7 illustrates a special game symbol table.

FIG. 8 illustrates a payout table.

FIG. 9 illustrates a feature game.

FIG. 10A illustrates a feature selection table.

FIG. 10B illustrates a feature selection table.

FIG. 10C illustrates a feature selection table.

FIG. 10D illustrates a feature selection table.

FIG. 10E illustrates a feature selection table.

FIG. 11 illustrates a special game selection table.

FIG. 12 illustrates a special game setting table.

FIG. 13 illustrates a progressive payout setting table.

FIG. 14 illustrates a progressive level/number table.

FIG. 15A illustrates a number of specific symbol determination table.

FIG. 15B illustrates a number of specific symbol determination table.

FIG. 15C illustrates a number of specific symbol determination table.

FIG. 15D illustrates a number of specific symbol determination table.

FIG. 15E illustrates a number of specific symbol determination table.

FIG. 16A illustrates a 3-symbol free game allocation pattern determination table.

FIG. 16B illustrates a 4-symbol free game allocation pattern determination table.

FIG. 16C illustrates a 5-symbol free game allocation pattern determination table.

FIG. 16D illustrates a 6-symbol free game allocation pattern determination table.

FIG. 16E illustrates a 7-symbol free game allocation pattern determination table.

FIG. 16F illustrates a 8-symbol free game allocation pattern determination table.

FIG. 17A illustrates a 0-symbol reel allocation pattern determination table.

FIG. 17B illustrates a 1-symbol reel allocation pattern determination table.

FIG. 17C illustrates a 2-symbol reel allocation pattern determination table.

FIG. 17D illustrates a 3-symbol reel allocation pattern determination table.

FIG. 17E illustrates a 4-symbol reel allocation pattern determination table.

FIG. 17F illustrates a 5-symbol reel allocation pattern determination table.

FIG. 18A illustrates a 1-symbol stop position determination table.

FIG. 18B illustrates a 0-symbol stop position determination table.

FIG. 19 is a flowchart of a main control process of the slot machine.

FIG. 20 is a flowchart of a bet/start check process of the slot machine.

FIG. 21 is a flowchart of a progressive jackpot related process of the slot machine.

FIG. 22 is a flowchart of a feature game process of the slot machine.

FIG. 23 is a flowchart of a progressive challenge process of the slot machine.

FIG. 24 is a flowchart of a special game process of the slot machine.

FIG. 25 is an explanatory diagram of a display window of the slot machine.

FIG. 26 is an explanatory diagram showing paylines related to an embodiment.

FIG. 27 illustrates a screen displayed by a liquid crystal display device of the slot machine.

FIG. 28 illustrates a screen displayed by an upper image display panel of the slot machine.

FIG. 29 illustrates a screen displayed by the upper image display panel of the slot machine.

FIG. 30 illustrates a reel unit in the progressive challenge process.

FIG. 31 illustrates a screen displayed by the upper image display panel in the progressive challenge process.

### DESCRIPTION OF THE PREFERRED EMBODIMENTS

(Outline of One Embodiment of Present Invention)

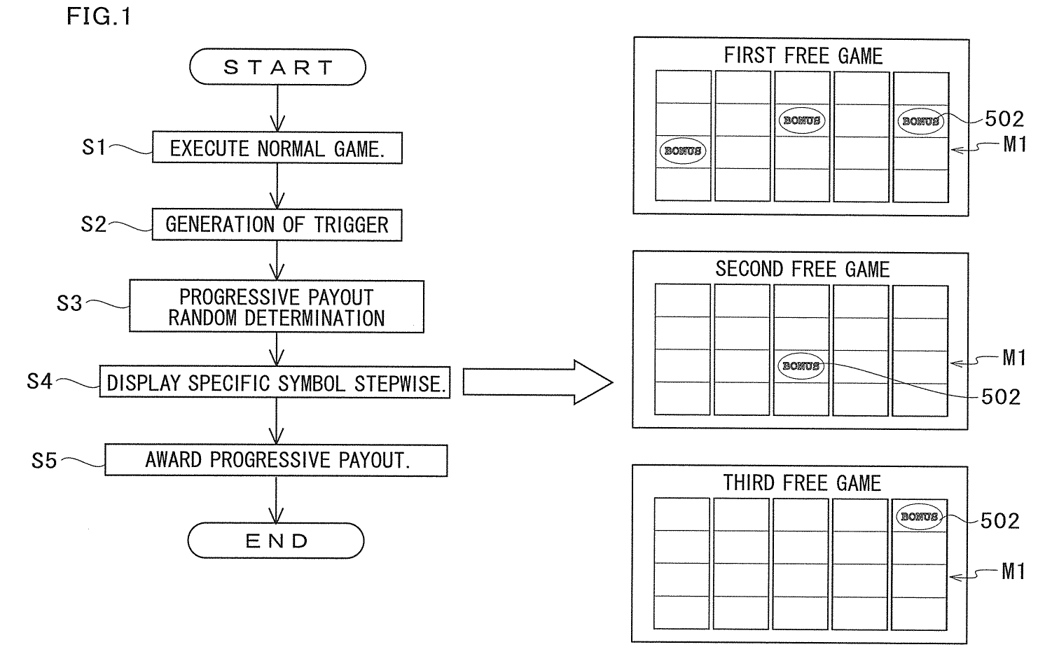

The following will describe an embodiment of the present invention with reference to figures. As shown in FIG. 1, a slot machine which is a gaming machine of the embodiment of the present invention has, as prizes, plural types of progressive payouts which are different in payout amounts.

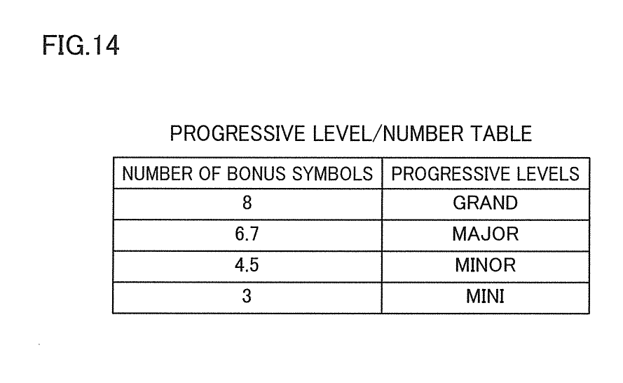

This slot machine 1 is provided with a reel unit M1 which displays five reels on which symbols including a specific symbol 502 are lined up. Furthermore, the slot machine stores types of progressive payout in association with numbers of the specific symbols (see a progressive level/number table shown in FIG. 14).

The slot machine 1 executes a normal game in which the symbols are rearranged on the reel unit M1 and a prize corresponding to the rearranged symbols is awarded (S1). When a trigger with which a progressive payout is awarded is generated in the normal game (S2), one of plural types of progressive payouts is randomly selected (S3). Then the number of the specific symbols 502 stored in association with the selected type of the progressive payout is displayed stepwise on the reel unit M1 (S4). In the present embodiment, as shown in FIG. 1, the specific symbols 502 are displayed stepwise on the reel unit M1 in such a way that the free game of rearranging the symbols on the reel unit M1 is executed three times. After the step S4, the selected progressive payout is awarded as a prize (S5).

In the slot machine 1, an effect indicating which one of the plural types of progressive payouts is awarded as a prize is performed by displaying the specific symbols 502 stepwise on the reel unit M1. In this way, as the symbols on the reel unit M1 displaying a game result in the normal game are used for the effect indicating which one of the plural types of progressive payouts is awarded as a prize, the effect is performed with a simple arrangement.

(Definitions and the Like)

The above described slot machine is a type of gaming machine. The present embodiment deals with a case where the slot machine 1 is the gaming machine; however, the present invention is not limited to this, and is applicable to any given gaming machine configured to independently run any type of normal game and award progressive payouts of plural types.

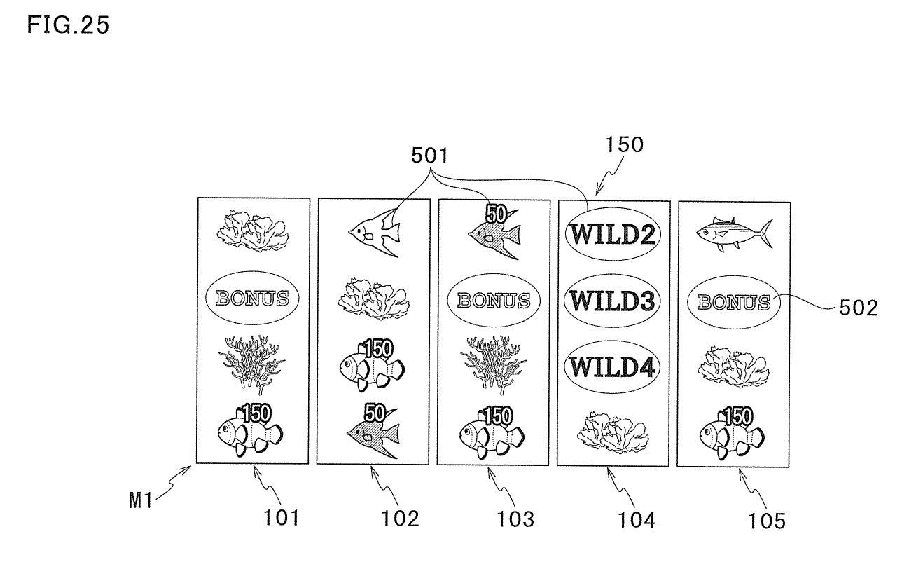

The normal game and the free game in the present embodiment are executed by the slot machine 1. Each of the normal game and the free game is a slot game where a plurality of symbols (see FIG. 25 and the like) are rearranged. The rearrangement of the symbols in the slot game is conducted on a reel unit. The normal game is a game in which, on condition that a game value is bet, symbols are rearranged in a display window by a reel unit and a payout corresponding to the rearranged symbols is awarded. In other words, the normal game is a game which starts with consumption of a game value. The free game is a game runnable with a bet of fewer game values than the normal game. Note that “bet of fewer amounts of game values” encompasses a bet of zero (0) game value. In the present embodiment, the “free game” is a game runnable without a condition of betting a game value. In other words, the “free game” may be a game which is started without consumption of a game value.

The free game in the present embodiment is executed plural times in the feature game when a winning condition of winning one of plural types of progressive payouts which are different in payout amounts is established. In short, the feature game includes execution of the free game plural times.

The feature game is equivalent to a bonus game and is executed when a predetermined condition is established in the normal game in the present embodiment. The feature game is a game which is more advantageous than the normal game, and another feature game may be additionally employed on condition that a state advantageous for the player, i.e., a state more advantageous than the normal game is achieved. For example, in the feature game, various states such as a state in which more game values can be achieved as compared to the normal game, a state in which the probability of obtaining a game value is higher than the probability in the normal game, and a state in which the number of consumed game values is smaller than in the normal game are achieved independently or in combination.

The progressive payout is, in a broad sense, a special payout different from normal payouts. In the present embodiment, the progressive payout is a payout formed by accumulating a part of a bet amount (bet number) bet in the slot machine each time the unit game is executed, and is awarded to the player when a predetermined condition is satisfied.

The symbols here collectively mean “WILD1”, “WILD2”, “WILD3”, “WILD4”, “ORCA”, “DOLPHIN”, “TURTLE”, “CLOWN FISH”, “YELLOW FISH”, “WHITE FISH”, “BLUE FISH”, “STARFISH”, “CORAL”, “SEAWEED”, and “BONUS”. Among these symbols , “BONUS” is a specific symbol. In the execution of the free game plural times in the feature game, one of the plural types of progressive payouts is awarded as a prize in accordance with the total number of the specific symbols rearranged in the display window.

In the present embodiment, the specific symbol functions as a trigger of the execution of the feature game. In the present embodiment, the specific symbol functions as a scatter symbol. That is to say, the trigger condition is established based solely on the number of the rearranged specific symbols, irrespective of the payline. “WILD1”, “WILD2”, “WILD3”, and “WILD4” can be used as a substitute for any type of the symbols except the specific symbol.

A game value is electrically valuable information such as electronic money. It is to be noted that the game value in the present invention is not limited to these, and game media such as a medal, a token, and a ticket can be adopted. The ticket may be, for example, a ticket with a barcode in which data such as a credit amount is encoded. Alternatively, the game value may be a game point not including valuable information.

The term “rearrangement” indicates that the symbols are rearranged after the arrangement of the symbols is dismissed. The term “arrangement” indicates a state in which the symbols are visually recognizable by an external player. More specifically, “rearrangement” is a state in which, after the symbols on the reels are variably displayed as the reels rotate, the variable display of the symbols stops as the rotation of the reels stops, and the symbols stop in the display window.

(Function Flow)

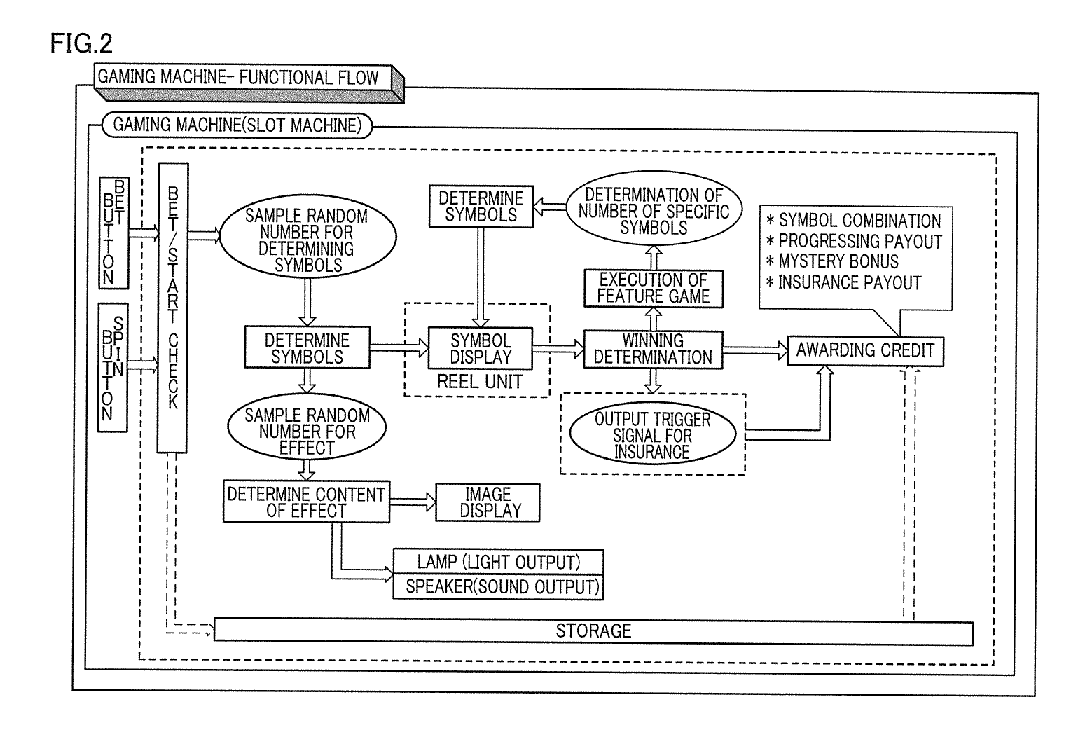

To begin with, the basic functions of the slot machine of the embodiment of the present invention will be described with reference to FIG. 2. FIG. 2 is a diagram showing a functional flow of the slot machine of the embodiment of the present invention.

(Bet/Start-Check)

First, the slot machine checks whether or not a BET button has been pressed by a player, and subsequently checks whether or not a spin button has been pressed by the player.

<Symbol Determination>

Next, when the spin button has been pressed by the player, the slot machine extracts a random number for symbol determination, and determines symbols to be displayed (rearranged) for the player at the time of stopping the scroll of reels, for respective reels.

(Reel Control)

Thereafter, the slot machine starts the rotation of each reel and stops the rotation of each reel so that the determined symbols are displayed for the player.

<Winning Determination>

Subsequently, as the rotation of each reel is stopped, the slot machine determines whether the combination of the symbols displayed for the player is a combination related to winning

<Awarding of Benefit>

When the combination of the symbols displayed for the player is a combination related to winning, the slot machine offers, to the player, benefit according to the combination. For example, when a combination of the symbols related to the awarding of credits, the slot machine awards credits to the player, the number of which corresponds to the combination of the symbols.

Furthermore, each time the unit game is executed, the slot machine accumulatively adds a part of the bet amount to each of the plural types of progressive payouts stored in a storage.

<Feature Game>

When a combination of the symbols functioning as the trigger of the feature game is displayed, the slot machine starts the feature game. In the feature game, when a predetermined condition is established, the slot machine determines the total number of the specific symbols which are displayed for the player when the rotation of the reels is stopped in plural times of execution of the free game. As detailed later, in the present embodiment, the determination of the total number of the specific symbols is equivalent to the selection of one progressive payout from the plural types of progressive payouts. Next, the slot machine determines symbols to be displayed for the player at the time of stopping the scroll of reels in each execution of the free game. Thereafter, each time the free game is executed, the slot machine starts the rotation of each reel and stops the rotation of each reel so that the determined symbols are displayed for the player. Subsequently, based on the total number of the specific symbols rearranged in the execution of the free game plural times, the slot machine determines which progressive payout is won among the plural types of progressive payouts. Then the progressive payout having been won is awarded to the player.

In addition to the above, the slot machine may have other benefits such as mystery bonus and insurance, in addition to the benefit above In the mystery bonus, a predetermined number of credits are paid out when a winning is achieved in dedicated random determination. In this case, when the spin button is pressed, the slot machine samples a random number for the mystery bonus and randomly determines whether a mystery bonus trigger is established.

The insurance is a function for saving the player when the feature game is not executed for a long period of time. When the insurance is activated, a predetermined insurance activation amount must be paid. When the insurance is activated, the slot machine starts to count the number of times of execution of the game. When the counted number of times reaches a predetermined number while a large amount of payout on account of the feature game or the like is not carried out, the slot machine pays out credits which have been set for the insurance.

<Determination of Effect>

The slot machine produces an effect by displaying an image on a display, outputting light from a lamp, and outputting sound from a speaker. The slot machine samples an effect-use random number and determines the content of an effect based on randomly determined symbols or the like.

[Overall Structure of Slot Machine]

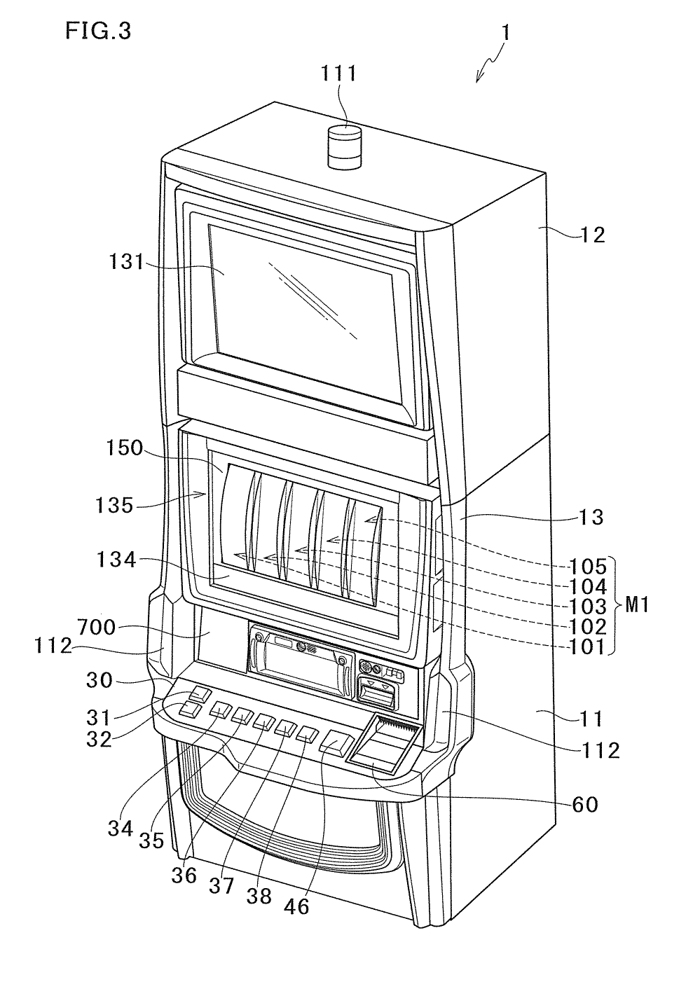

Now, referring to FIG. 3, the overall structure of the slot machine 1 will be described. FIG. 3 shows the overall structure of the slot machine of the embodiment of the present invention.

In the slot machine 1 the game value is electronic valuable information such as electronic money. The game value is not limited to this. For example, coins, medals, tokens, and tickets with barcodes may be employed.

The slot machine 1 includes a cabinet 11, a top box 12 installed on the upper side of the cabinet 11, and a main door 13 provided at the front surface of the cabinet 11. The cabinet 11 is provided with a lamp 111.

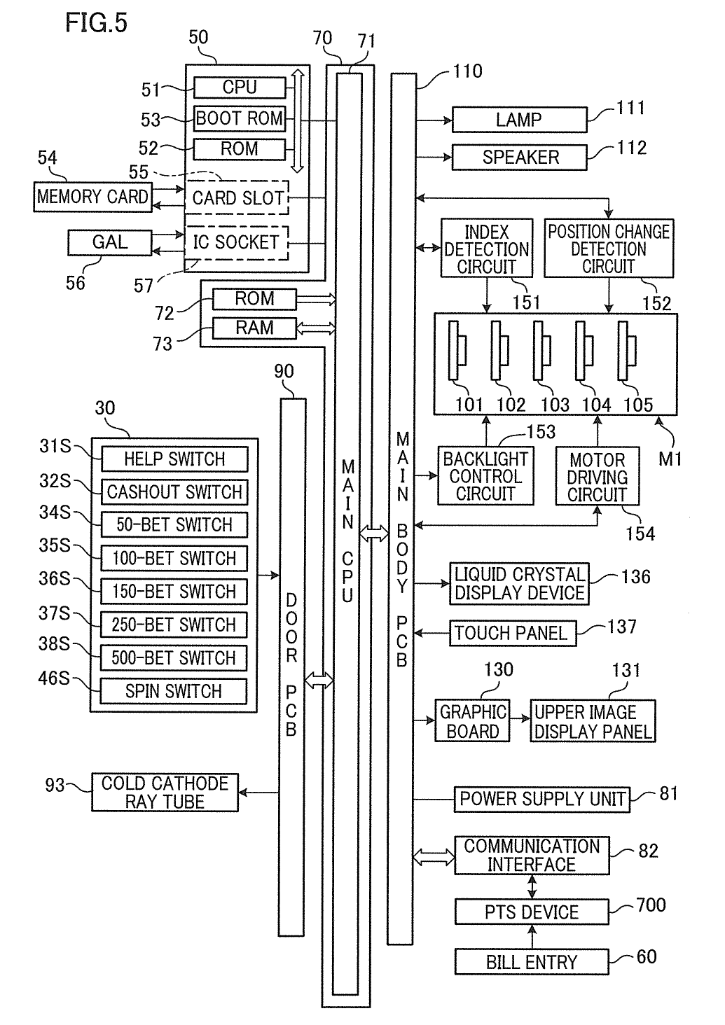

The main door 13 is provided with a reel unit M1 (corresponding to a display device) constituted by five reels 101, 102, 103, 104, and 105. On the front surface of the reel unit M1 is provided a reel cover 135. On the front surface of the reel cover 135, a liquid crystal display device 134 by which a game status is notified to the player and a transparent panel are provided. This liquid crystal display device 134 is provided with a touch panel 137 (see FIG. 5). The reel cover 135 has a display window 150 at the central portion. In accordance with the reels 101 to 105, the display window 150 displays one symbol 501 (see FIG. 25) in each of the upper stage, the upper middle stage, the lower middle stage, and the lower stage. To put it differently, 20 symbols 501 forming a 5 by 4 matrix are displayed in the display window 150. On the outer circumferential surface of each of the reels 101, 102, 103, 104, and 105, 22 symbols are depicted. These 22 symbols 501 are lined up along the rotational direction of the reels 101, 102, 103, 104, and 105 to form a symbol column. Each of the symbol columns is a combination of “WILD1”, “WILD2”, “WILD3”, “WILD4”, “ORCA”, “DOLPHIN”, “TURTLE”, “CLOWN FISH”, “YELLOW FISH”, “WHITE FISH”, “BLUE FISH”, “STARFISH”, “CORAL”, “SEAWEED”, and “BONUS”. The main door 13 is provided with a speaker 112.

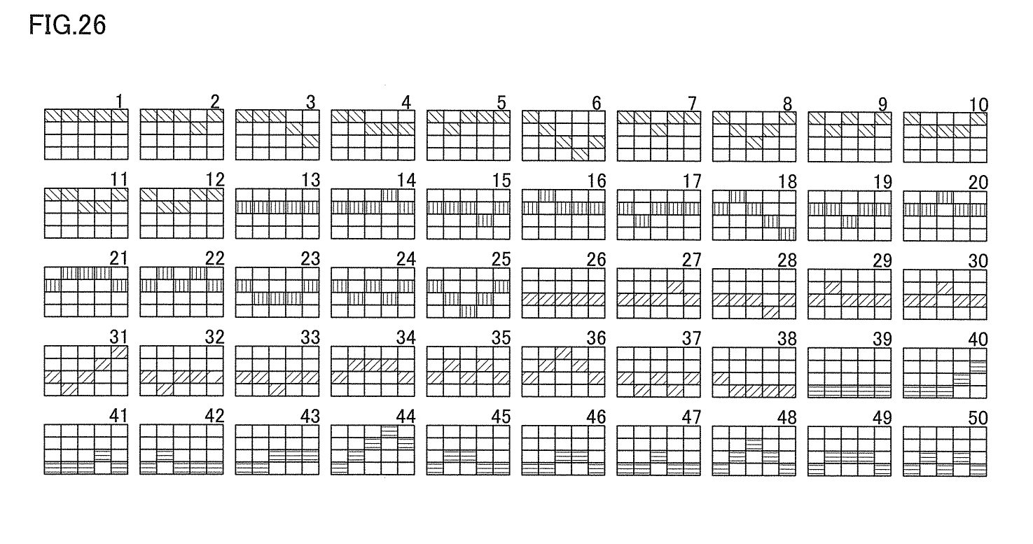

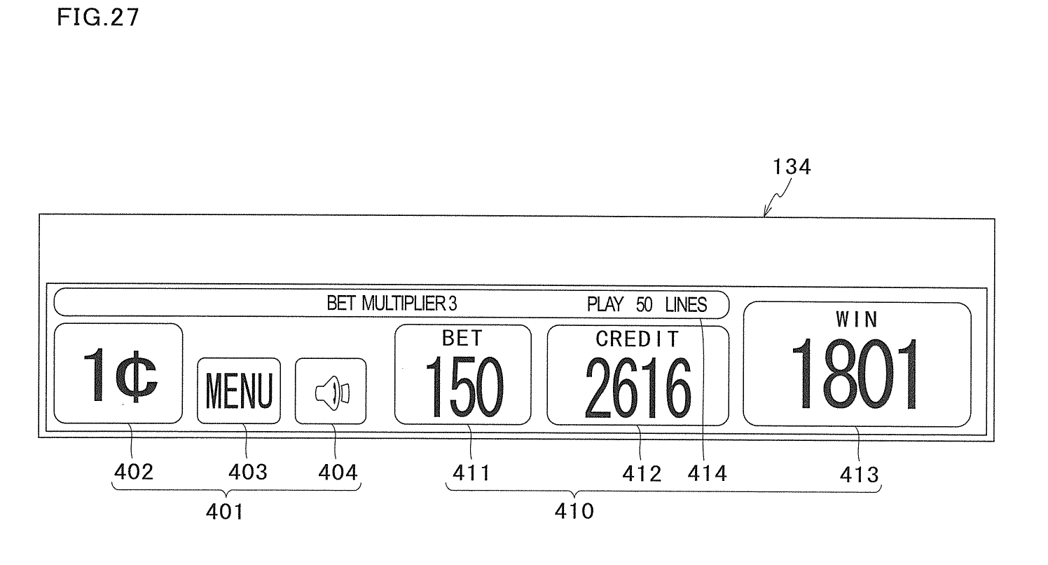

As show in FIG. 26, paylines are arranged in the slot machine 1, for winning determination based on the symbols 501 rearranged on the display windows 150. In the present embodiment, there are a total of 50 paylines as shown in FIG. 26. In the present embodiment, all of the 50 paylines are activated at once irrespective of the bet amount, when the game is executed. As a modification, each payline may be activated in accordance with selection by the player.

In the descriptions below, winning achieved according to a payline will be referred to as line winning, whereas winning achieved by a scattered symbol will be referred to as scattered winning

As shown in FIG. 25, the reel unit M1 rearranges the symbols 501 on the display windows 150 by drivingly rotating the reels 101, 102, 103, 104, and 105 each having the symbols 501 on the outer circumferential surface. In the descriptions below, the reels may be referred to as a first reel 101, a second reel 102, a third reel 103, a fourth reel 104, and a fifth reel 105 from the left end in front elevation.

On the inner circumferential side of each of the reels 101, 102, 103, 104, and 105 arranged as above, a backlight unit (not illustrated) is provided. The backlight unit is arranged so that illuminating light is emitted from the inner circumferential side of the reels 101, 102, 103, 104, and 105 toward the outer circumferential surface side of the reels so that the illumination light passing through the outer circumferential surfaces of the reels is viewable from the outside of the display windows 150. The backlight unit is configured to be able to change the amount of illumination light in multiple stages. The degree of freedom in the effects using illumination light is therefore high. Furthermore, the backlight unit is able to emit light in multiple colors. The symbols are illuminated with the illumination light of the following colors.

It should be noted that the present embodiment deals with a case where the slot machine 1 employs the reel unit M1 in the form of mechanical reels; however, the slot machine 1 of the present invention may adopt video reels that display simulated reels, or adopt a combination of the video reels and the mechanical reels.

As shown in FIG. 27, the liquid crystal display device 134 displays a touch button group 401 by which an input from the player is received, and a meter group 410 by which the state of the game is notified. The touch button group 401 is formed of a denomination button 402, a menu button 403, and a sound volume switch button 404.

The denomination button 402 displays current denomination set in the AUDIT. A menu screen is displayed when the menu button 403 is touched. The sound volume switch button 404 switches the game sound volume in, for example three stages. Each time the button is touched, the game sound volume is switched from small to middle to large to small to middle, and so on.

The meter group 410 is formed of a bet meter 411, a credit meter 412, a win meter 413, and a line meter 414. The bet meter 411 displays a bet amount. The bet amount is re-calculated each time the game is executed. The credit meter 412 indicates the total credit amount at the time. The total credit amount is initially zero, and increases or decreases in accordance with an input of a game value, betting, and a game result. The win meter 413 increments and displays the total credit of the prizes having been won. The line meter 414 displays the number of activated paylines and a value of “MULTIPLIER” which will be described later.

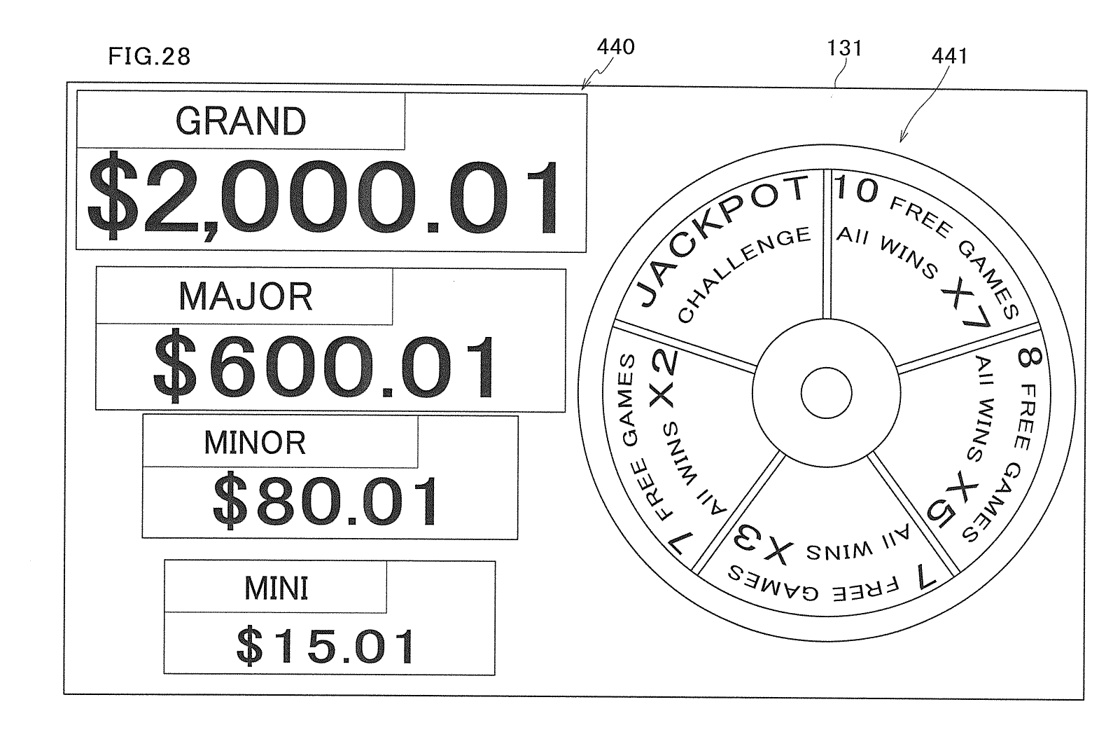

An upper image display panel 131 is provided at the front face of the top box 12. The upper image display panel 131 includes a liquid crystal panel, and forms the display. The upper image display panel 131 displays images related to effects and images showing introduction of the game contents and explanation of the game rules. In the present embodiment, as shown in FIG. 28, the upper image display panel 131 displays a progressive payout screen 440 which indicates payout amounts of four types of progressive jackpots (equivalent to the progressive payouts) and a roulette 441 which is used in an effect in the feature game. This roulette 441 has five areas corresponding to a later-described progressive challenge and four types of special games, respectively. In the feature game, as these five areas are lighted (equivalent to a winning mark) one by one, an effect which shows as if random determination by the roulette is in progress is performed. In the effect, as each area is repeatedly lighted and darkened, the five areas are as if selected one by one.

Below the reel unit M1, a control panel 30 on which buttons are provided, a PTS device 700, and a bill entry 60 are provided.

The bill entry 60 validates a bill, and accepts a genuine bill into the cabinet 11. This bill entry 60 is electrically connected with the PTS device 700. When receiving a genuine bill, the bill entry 60 sends an input signal based on the amount of the bill to the PTS device 700. This input signal includes information such as credit data regarding the received bill.

The PTS device 700 is a unit in which a LCD (liquid crystal display), a human detection camera, a microphone, and the like are integrated. The human detection camera is configured to detect the presence of a player by a camera function. The microphone allows a player to participate in a game by sound or authorizes a player by voice recognition. The PTS device 700 is provided with a card insertion slot through which an IC card is inserted. This allows the player to insert an IC card into the card insertion slot and use credits stored in the IC card in the slot machine 1.

(Control Panel 30)

On the control panel 30, a HELP button 31 and a CASHOUT button 32 are provided in the left side area, a 50-BET button 34, a 100-BET button 35, a 150-BET button 36, a 250-BET button 37, and a 500-BET button 38 are provided in the central area, and a spin button 46 is provided in the right side area.

The help button 31 is pressed when, for example, it is unclear how to play a game. As the help button 31 is pressed, various help information is displayed on a liquid crystal display device 134. The cashout button 32 is an operation button to be used for cashing out credits stored in the slot machine 1.

The 50-bet button 34 is used for placing a bet of 50 credits out of the credits owned by the player, every time it is pressed. The 100-bet button 35 is used for starting the game with a bet of 100 credits. The 150-bet button 36 is used for starting the game with a bet of 150 credits. The 250-bet button 37 is used for starting the game with a bet of 250 credits. The 500-bet button 38 is used for starting the game with a bet of 500 credits. As such, the bet amount on each active payline is determined by pressing the 50-BET button 34, the 100-BET button 35, the 150-BET button 36, the 250-BET button 37, or the 500-BET button 38. In the present embodiment, an amount bettable on single execution of the game is 50, 100, 150, 200, 250, 500, or 1000.

The spin button 46 is used to start the scroll of the reels 101, 102, 103, 104, and 105.

(symbol Column)

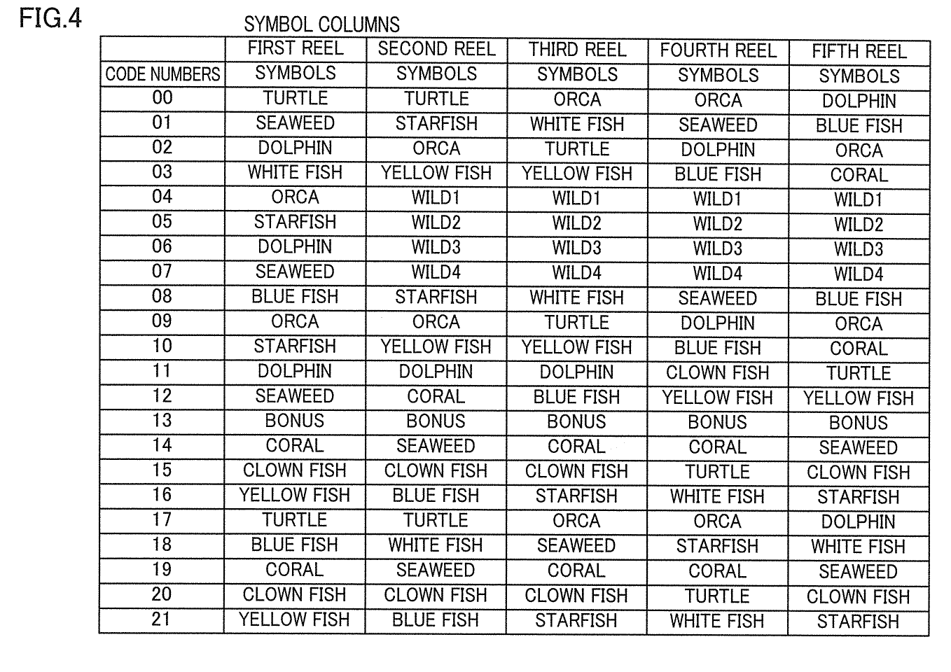

Next, with reference to FIG. 4, the following describes arrays of symbols 501 on the first reel 101, the second reel 102, the third reel 103, the fourth reel 104, and the fifth reel 105 of the slot machine 1.

FIG. 4 shows arrays of symbols 501 which are displayed on the outer circumferential surfaces of the reels. To each of the first reel 101, the second reel 102, the third reel 103, the fourth reel 104, the fifth reel 105 is assigned a symbol column including 22 symbols 501 respectively corresponding to code numbers 00 to 21.

As shown in FIG. 4, the types of symbols include “WILD1”, “WILD2”, “WILD3”, “WILD4”, “ORCA”, “DOLPHIN”, “TURTLE”, “CLOWN FISH”, “YELLOW FISH”, “WHITE FISH”, “BLUE FISH”, “STARFISH”, “CORAL”, “SEAWEED”, and “BONUS”. It should be noted that the “WILD1”, “WILD2”, “WILD3”, and “WILD4” are all illustrated only on the outer circumferential surfaces of the reels 102 to 105. One “BONUS” which is the specific symbol 502 is depicted on each of the reels 101 to 105. That is to say, in the present embodiment, the number of the specific symbols 502 rearrangeable in the display window 150 in the execution of the game once is five. Not limited to this, the number of the specific symbols 502 rearrangeable in the display window 150 in the execution of the game once may be one or more.

[Structures of Circuits Provided in Slot Machine]

Next, with reference to FIG. 5, a configuration of a circuit included in the slot machine 1 is described. FIG. 5 is a block diagram showing an internal structure of the slot machine of the embodiment of the present invention.

A gaming board 50 is provided with a CPU 51, a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes a nonvolatile memory, and stores a game program. The game program includes a program related to game progression and a program for producing effects by images and sounds.

Furthermore, the card slot 55 is configured so that the memory card 54 can be inserted thereinto and removed therefrom, and is connected to a motherboard 70 by an IDE bus. The type and contents of the game to be played on the slot machine 1 can be changed by drawing out the memory card 54 from the card slot 55, writing another game program into the memory card 54, and inserting the memory card 54 into the card slot 55.

The GAL 56 is a type of PLD (programmable Logic Device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents and settings of the game to be played on the slot machine 1 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the pre-authentication program, and the like. The authentication program is a program (falsification check program) for authenticating the game program. The pre-authentication program is a program for authenticating the aforementioned authentication program. The authentication program and the pre-authentication program are written along a procedure (authentication procedure) for proving that the program to be the subject has not been falsified.

The motherboard 70 is provided with a main CPU 71, a ROM 72, a RAM 73, and a communication interface 82. The ROM 72 and the RAM 73 are equivalent to storages.

The ROM 72 includes a memory device such as a flash memory, and stores a program such as BIOS to be executed by the main CPU 71, and permanent data. When the BIOS is executed by the main CPU 71, a process for initializing predetermined peripheral devices is executed. Further, through the gaming board 50, a process of loading the game program stored in the memory card 54 is started.

The processor of the present invention includes the main CPU 71, the ROM 72, and the RAM 73 above and the memory card 54 storing the game program, and controls the slot machine by causing the CPU 71 to execute the game program. Needless to say, the processor may alternatively store the game program in the ROM 72 instead of the memory card 54.

The RAM 73 stores data and programs which are used in operation of the main CPU 71. For example, when the process of loading the aforementioned game program or authentication program is executed, the RAM 73 can store the program. The RAM 73 is provided with working areas used for operations in execution of these programs. Examples of the areas include: an area that stores counters for the number of games, the bet amounts, the credit amounts, the progressive payouts and each payout values, and an area that stores symbols (code numbers) randomly determined.

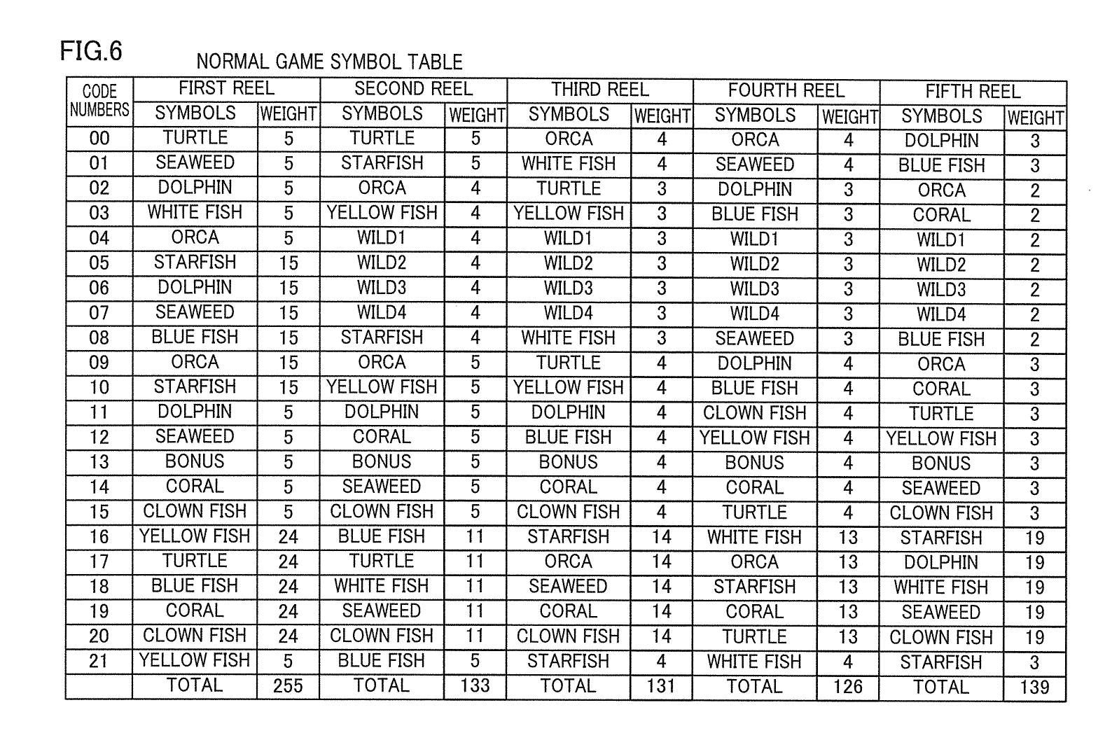

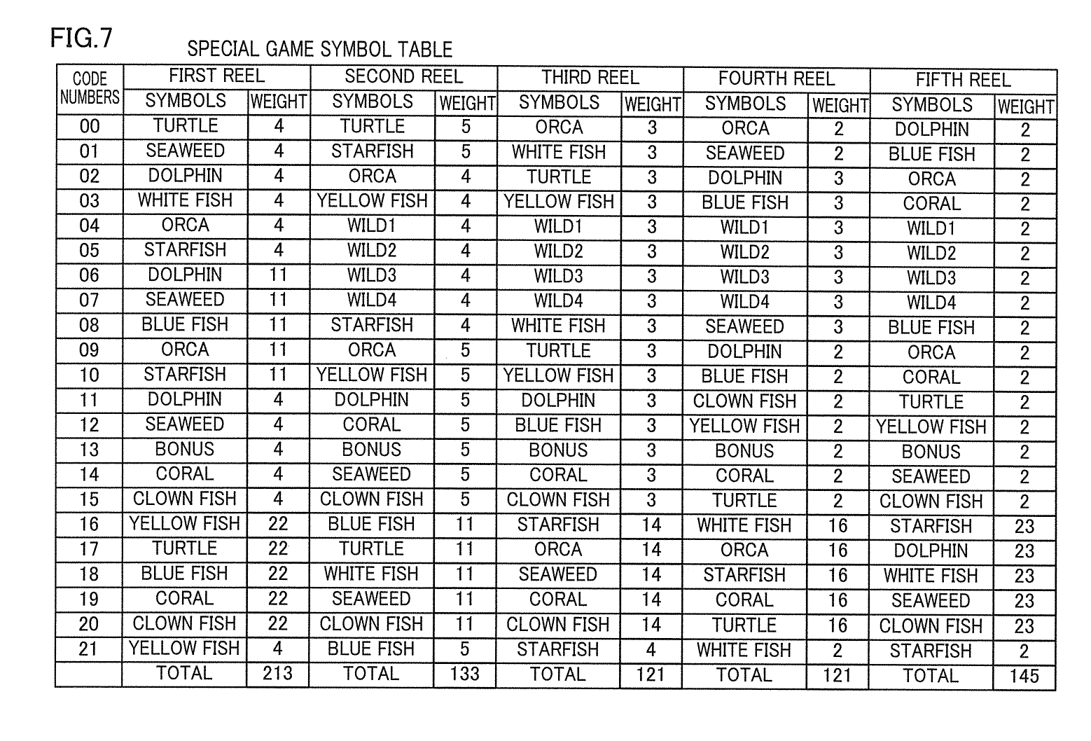

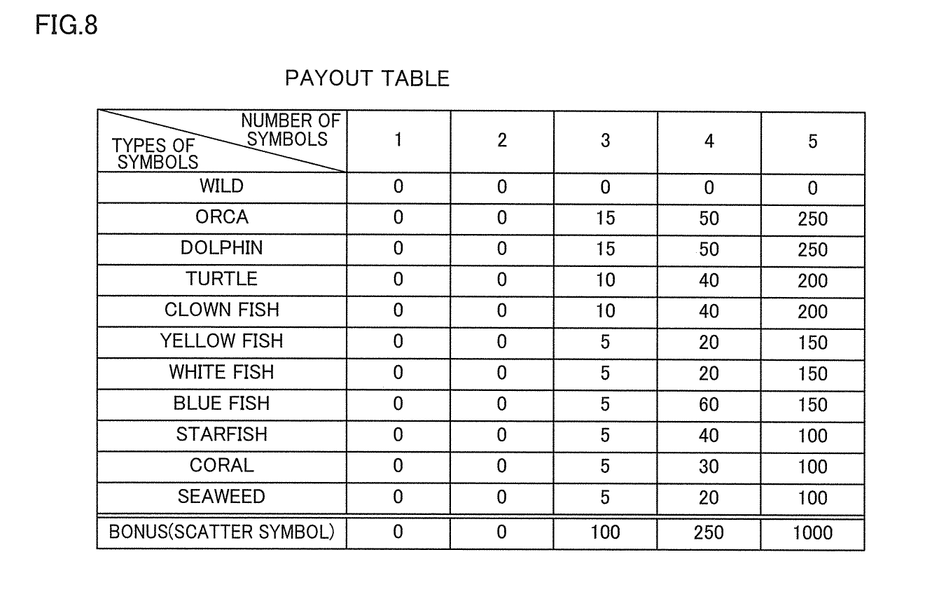

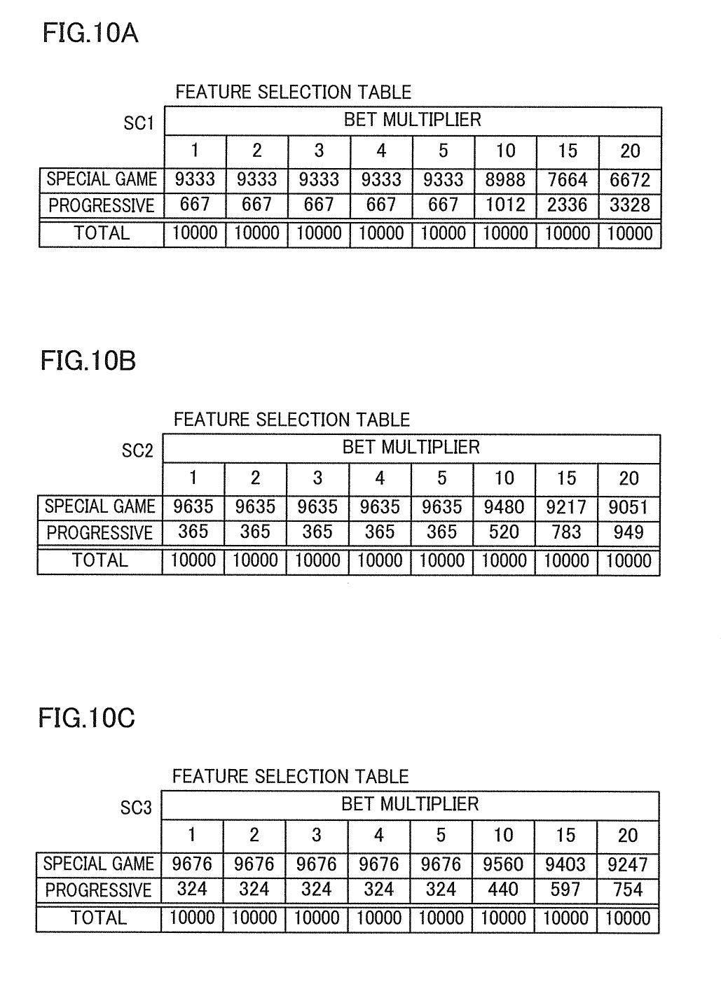

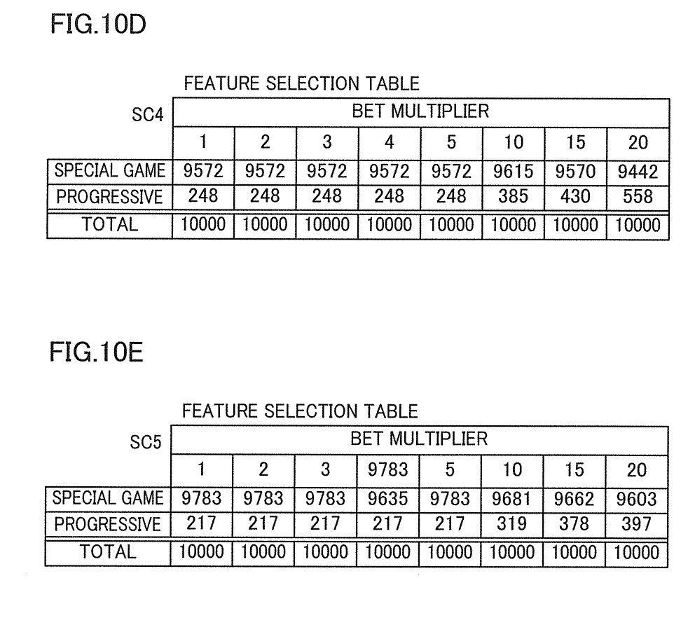

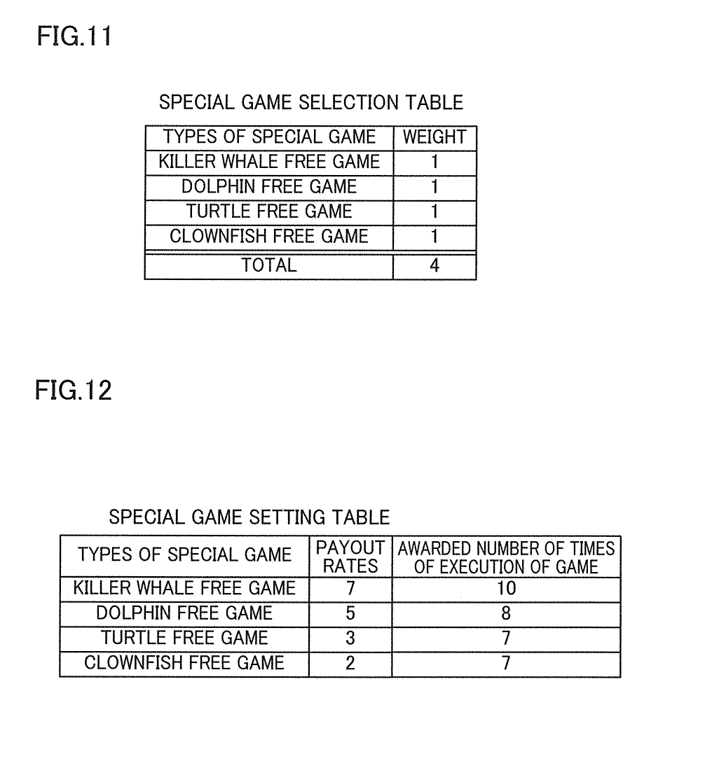

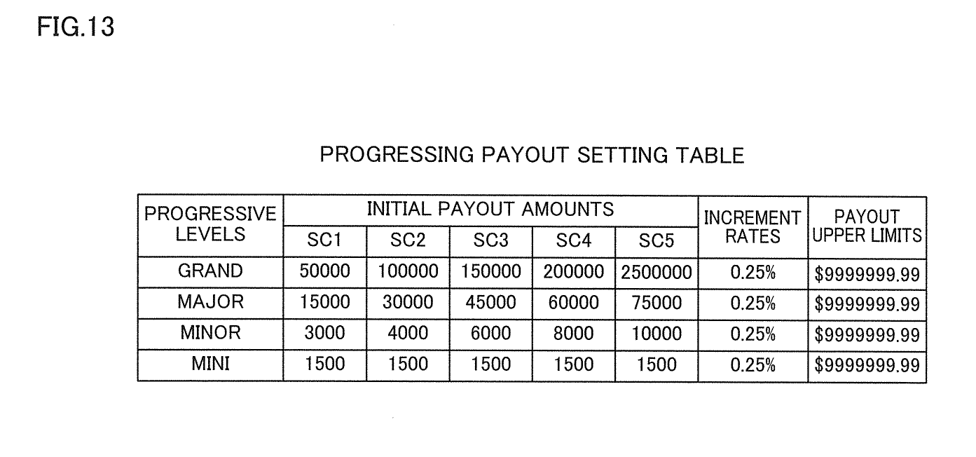

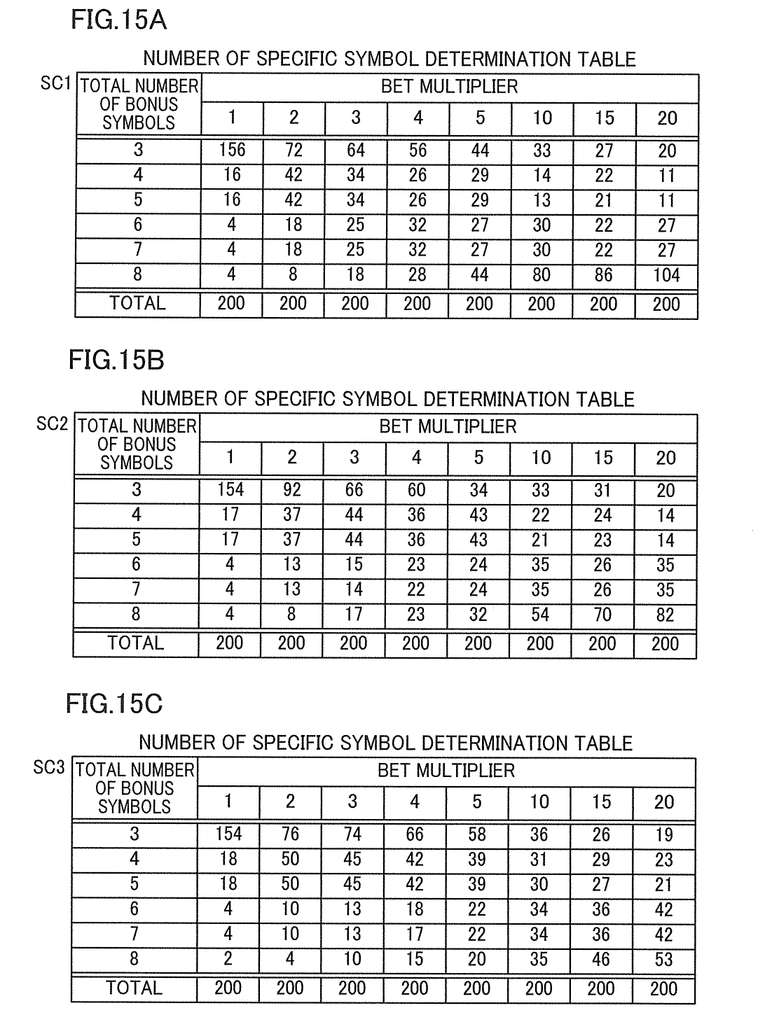

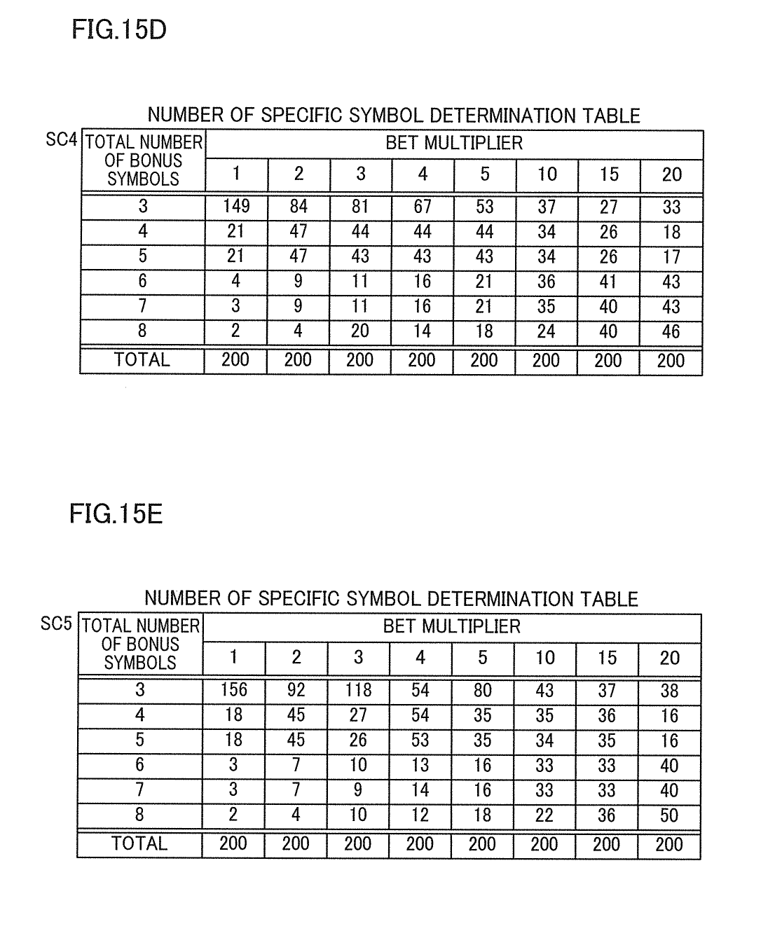

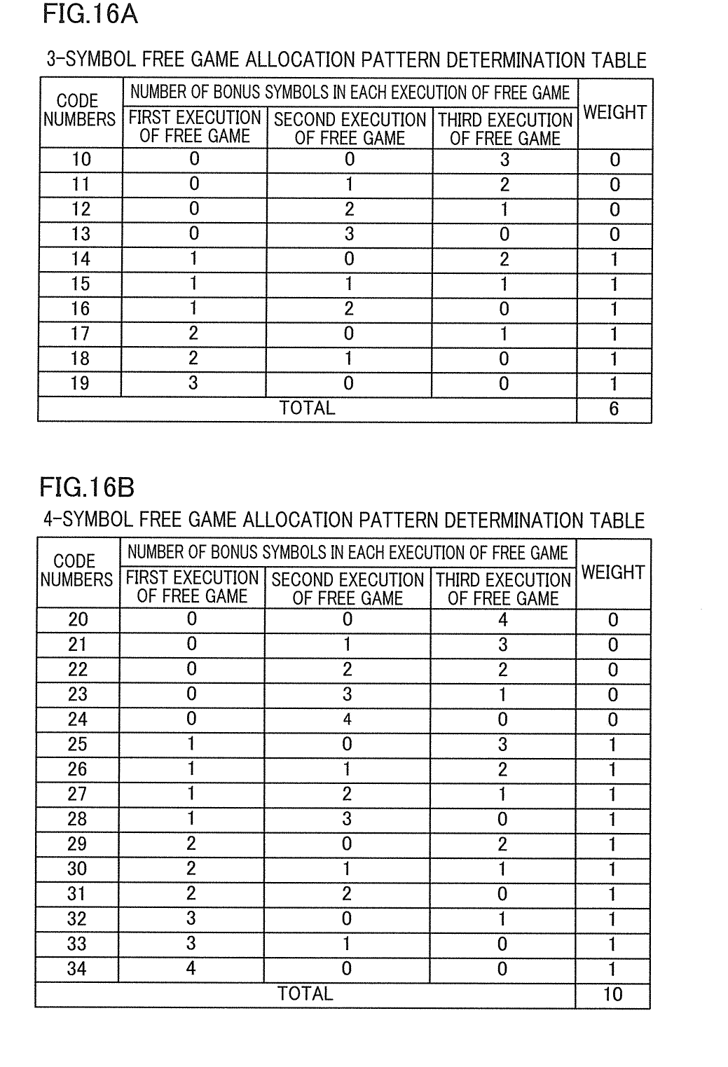

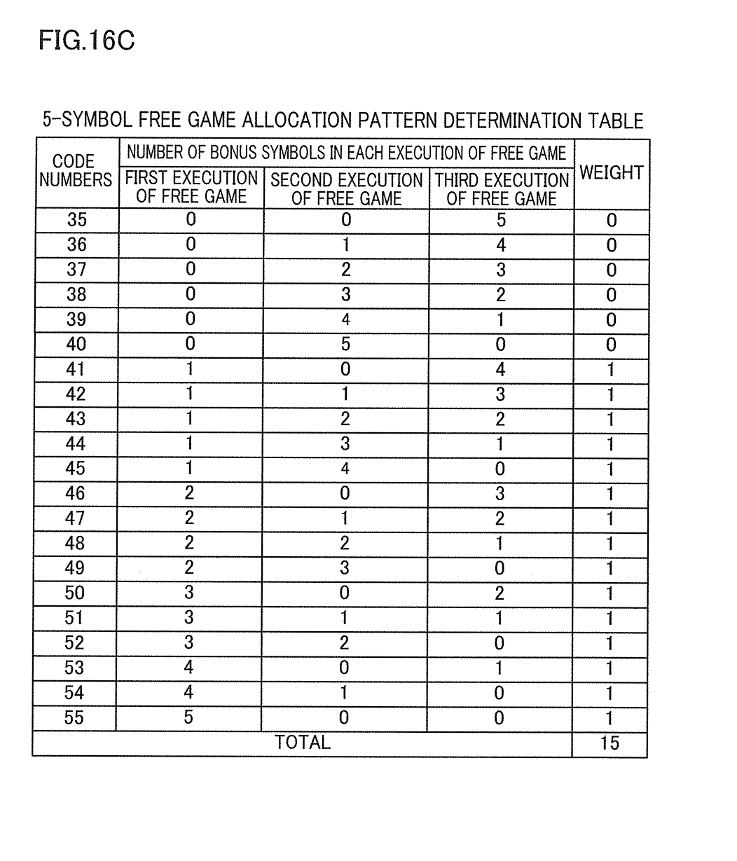

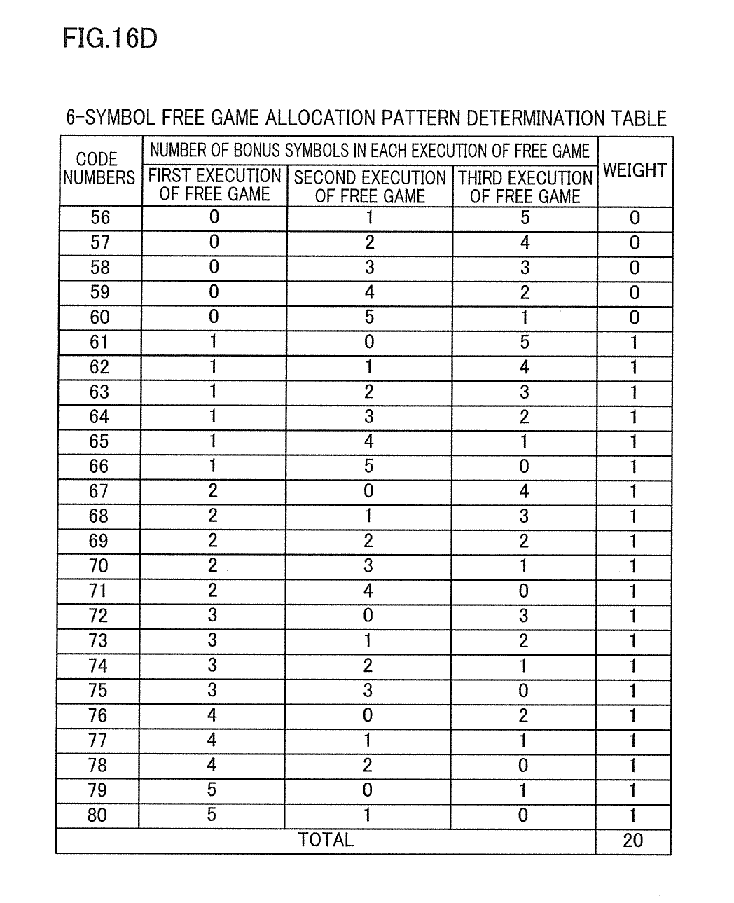

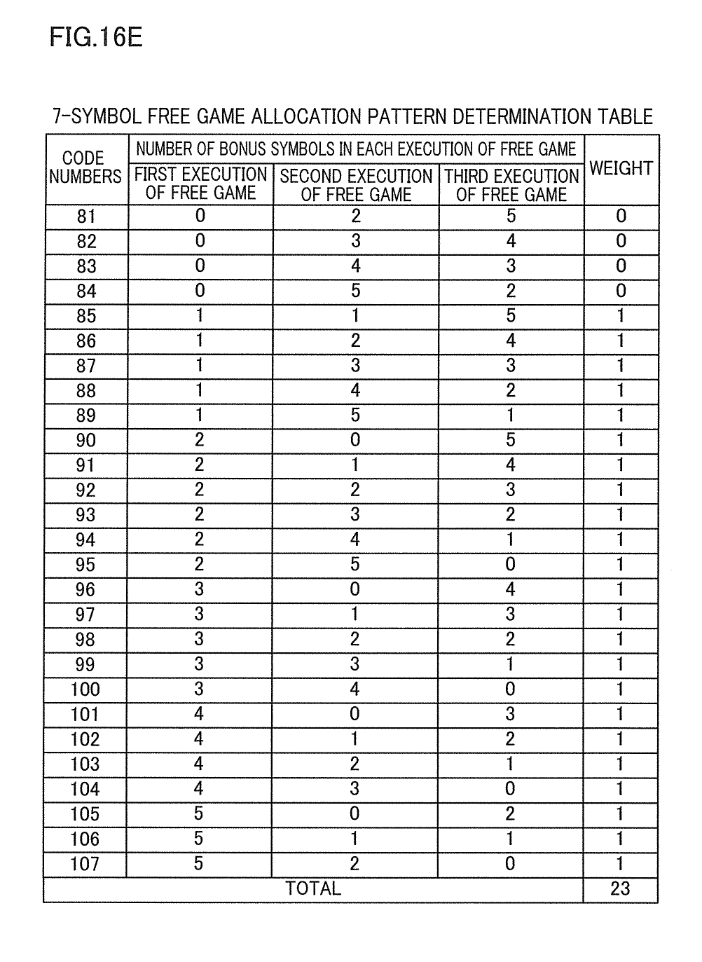

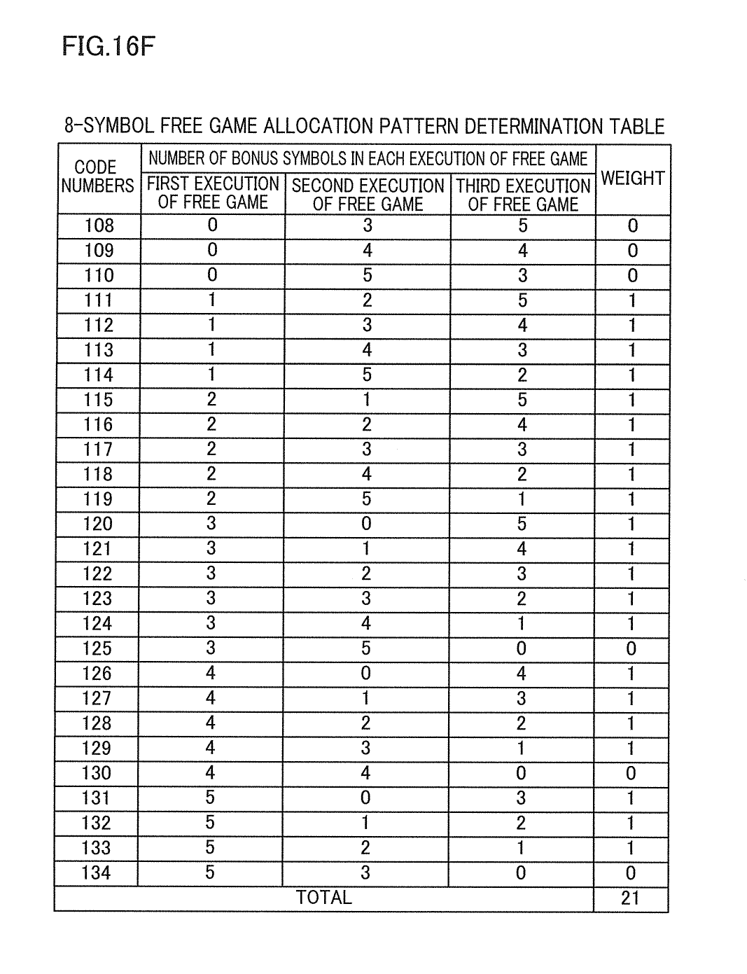

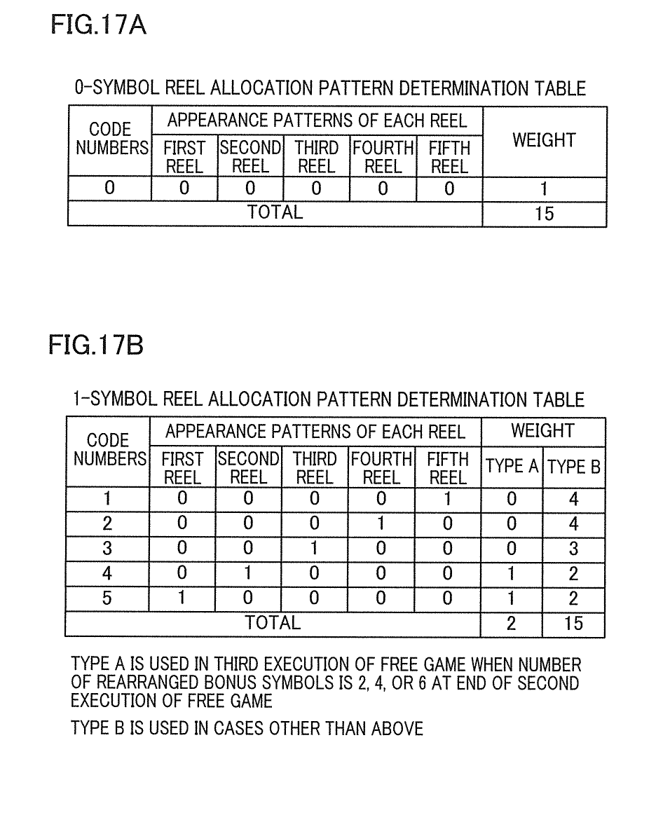

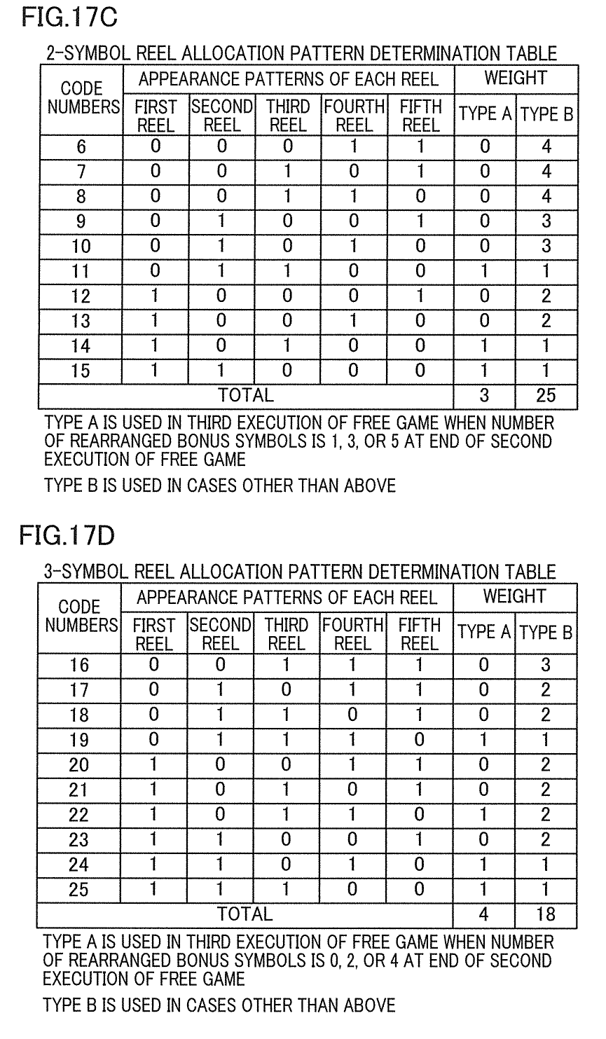

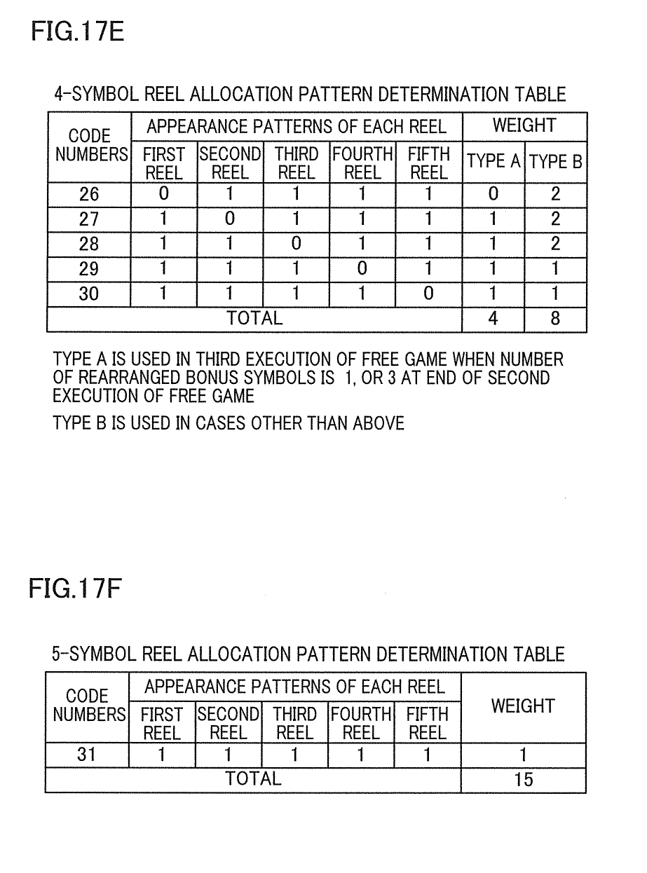

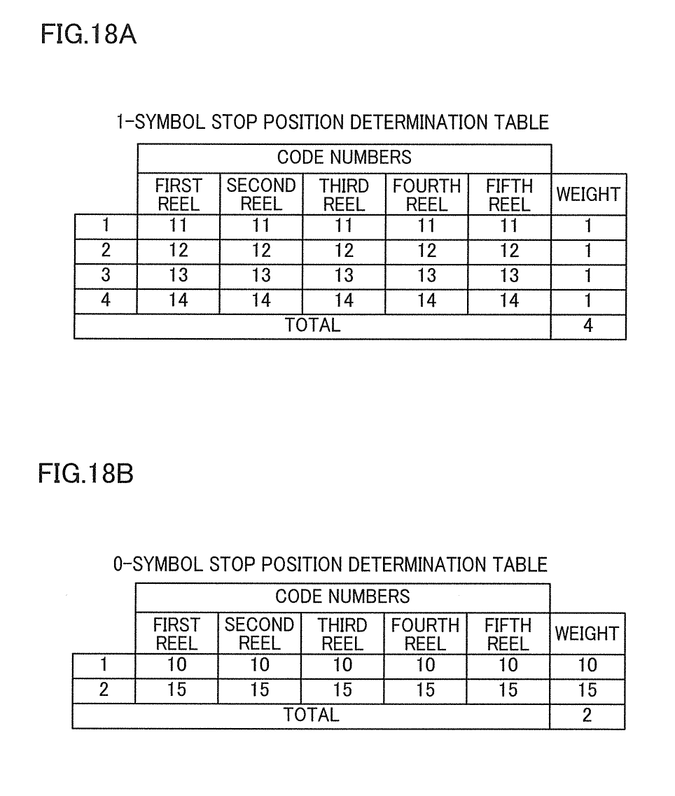

The RAM 73 stores tables such as a normal game symbol table (see FIG. 6), a special game symbol table (see FIG. 7), a payout table (see FIG. 8), a feature selection table (see FIG. 10A to FIG. 10E), a special game selection table (see FIG. 11), a special game setting table (see FIG. 12), a progressive payout setting table (see FIG. 13), a progressive level/number table (see FIG. 14), a number of specific symbol determination table (see FIG. 15A to FIG. 15E), a free game allocation pattern determination table (see FIG. 16A to FIG. 16F), a reel allocation pattern determination table (see FIG. 17A to FIG. 17F), and a stop position determination table (see FIG. 18A and FIG. 18B).

The communication interface 82 is provided for communicating with the PTS device 700 and an unillustrated external controller. Upon receiving the input signal from the bill entry 60, the PTS device 700 sends the credit data in the input signal to the main CPU 71 via the communication interface 82. When the IC card is inserted into the card insertion slot, the PTS device 700 sends the credit data stored in the IC card to the main CPU 71 via the communication interface 82. Furthermore, based on the control signal received from the main CPU 71 via the communication interface 82, the PTS device 700 writes credit data into the IC card inserted into the card insertion slot.

Further, the motherboard 70 is connected with a later-described door PCB (Printed Circuit Board) 90 and a main body PCB 110 by respective USBs. The motherboard 70 is also connected with a power supply unit 81. When the power is supplied from the power supply unit 81 to the motherboard 70, the main CPU 71 of the motherboard 70 is activated, and then the power is supplied to the gaming board 50 through the PCI bus so as to activate the CPU 51.

The door PCB 90 and the main body PCB 110 are connected with input devices such as a switch and a sensor, and peripheral devices the operations of which are controlled by the main CPU 71. The door PCB 90 is connected with a control panel 30 and a cold cathode tube 93.

The control panel 30 is provided with a HELP switch 31S, a CASHOUT switch 32S, a 50-BET switch 34S, a 100-BET switch 35S, a 150-BET switch 36S, a 250-BET switch 37S, a 500-BET switch 38S,and a spin switch 46S to correspond to the respective buttons. Each of the switches outputs a signal to the main CPU 71 upon detection of the pressing of the button corresponding thereto by the player.

The cold cathode tube 93 functions as a backlight installed on the rear face side of the upper image display panel 131, and lights up based on a control signal output from the main CPU 71.

The main PCB 110 is connected with a lamp 111, a speaker 112, a graphic board 130, a liquid crystal display device 136, a touch panel 137, an index detection circuit 151, a position change detection circuit 152, a backlight control circuit 153, and a motor driving circuit 154. The index detection circuit 151, the position change detection circuit 152, the backlight control circuit 153, and the motor driving circuit 154 are connected to the reel unit M1.

The lamp 111 turns on based on a control signal outputted from the main CPU 71. The speaker 112 outputs sounds such as BGM, based on a control signal outputted from the main CPU 71.

The graphic board 130 controls image display executed by the upper image display panel 131 based on a control signal outputted from the main CPU 71. The graphic board 130 is provided with a VDP (Video Display Processor) generating image data, a video RAM temporarily storing the image data generated by the VDP, and the like. It is to be noted that the image data used in generation of image data by the VDP is included in the game program that has been read from the memory card 54 and stored into the RAM 73.

The liquid crystal display device 136 displays an image based on a control signal output from the main CPU 71. The touch panel 137 detects a place on the liquid crystal display device 136 touched by the player's finger or the like, and outputs to the main CPU 71 a signal corresponding to the detected place.

The motor driving circuit 154 is connected to a stepper motor that rotates the reels 101, 102, 103, 104, and 105. The motor driving circuit 154 is provided with a FPGA (Field Programmable Gate Array) 155 and a driver. The FPGA 155 is a programmable electronic circuit such as LSI and functions as a control circuit of the stepper motor. The driver functions as an amplifying circuit for amplifying a pulse input to the stepper motor.

The index detection circuit 151 detects the positions of the rotating reels 101, 102, 103, 104, and 105 and is able to detect the step out of the reels 101, 102, 103, 104, and 105.

The position change detection circuit 152 detects a change in the stop positions of the reels 101, 102, 103, 104, and 105 after the rotation of the reels 101, 102, 103, 104, and 105 is stopped. The position change detection circuit 152 detects a change in the stop positions of the reels 101, 102, 103, 104, and 105 when, for example, a stop position is changed to achieve a winning combination of the symbols 501 by an illicit way when no winning combination of the symbols 501 is achieved. The position change detection circuit 152 is configured to be able to detect a change in the stop positions of the reels 101, 102, 103, 104, and 105 by, for example, detecting unillustrated fins attached at predetermined intervals to the inner circumferential part of each of the reels 101, 102, 103, 104, and 105.

The method of magnetic excitation of the stepper motor is not particularly limited; 1-2 phase excitation or 2 phase excitation may be employed. Furthermore, a DC motor may be used in place of the stepper motor. When a DC motor is used, an error counter, a D/A converter, and a servo amplifier are connected to the body PCB 110 in this order, and the servo amplifier is connected to the DC motor. The rotational position of the DC motor is detected by a rotary encoder, and a current rotational position of the DC motor is supplied as data from the rotary encoder to the error counter.

The backlight control circuit 153 is connected to the backlight units to individually supply driving power thereto. Upon receiving an instruction from the main CPU 71, the backlight control circuit 153 changes the amount of light emitted in multiple stages. The five backlight units provided on the inner circumference surfaces of the reels 101, 102, 103, 104, and 105 are able to individually illuminate 20 symbols 501 having stopped on the display windows 150 by means of the backlight control circuit 153.

[Normal Game Symbol Table]

Now, the normal game symbol table will be described with reference to FIG. 6.

As shown in FIG. 6, in each of the reels 101 to 105, weight values corresponding to the normal game are set for the 22 symbols corresponding to the code numbers 00 to 21. The weight indicates the probability of the rearrangement of the corresponding symbol 501 in the upper middle stage of the display window 150. For this reason, the probability of the rearrangement of the corresponding symbol 501 in the upper middle stage of the display window 150 is a value calculated by dividing the weight of the code number of that symbol by the total weight of the code numbers of all symbols. For example, as shown in FIG. 6, the “TURTLE” corresponding to the code number 00 of the first reel 101 is rearranged in the upper middle stage of the display window 150 at a probability of 5/255. Further, the “TURTLE” corresponding to the code number 00 of the second reel 102 is rearranged in the upper middle stage of the display window 150 at a probability of 5/133.

The slot machine 1 of the present embodiment has plural types of game settings to correspond to rules (regulations) which are different between countries and/or regions, and the AUDIT is arranged so that one of these settings is selectable. To be more specific, there are five major settings which are SC (Setting Combination) 1 to SC5. In each of SC1 to SC5, there are seven minor settings V01 to V07. To put it differently, there are 35 types of game settings in the present embodiment, and the AUDIT is arranged so that one of these 35 types is selectable. 35 types of the symbol tables are provided to correspond to 35 types of game settings, and FIG. 6 shows a symbol table corresponding to one of these 35 types of game settings.

[Special Game Symbol Table]

In the later-described four types of the special games, a special game symbol table shown in FIG. 7 is used. In this special game symbol table, a weight value corresponding to each type of the special game is set. 35 types of the special game symbol tables are provided to correspond to 35 types of game settings.

[Payout Table]

Now, referring to FIG. 8, a payout table will be described. The payout table shown in FIG. 8 defines combinations (numbers of symbols) of the symbols with which a winning (WIN) is achieved and awarded credit amounts. In the slot machine 1, a winning (line winning) is achieved when the scroll of the symbol columns of the reel 101 to 105 is stopped and a combination of the symbols displayed on a payline corresponds to a combination of the symbols defined in the payout table. In accordance with the winning, a benefit such as awarding of credits is awarded to the player. It is noted that a winning is not established (i.e. the game is lost) when the combination of symbols displayed on the payline does not match any of the combinations of symbols specified by the payout table.

Basically, in cases of each of the “ORCA”, “DOLPHIN”, “TURTLE”, “CLOWN FISH”, “YELLOW FISH”, “WHITE FISH”, “BLUE FISH”, “STARFISH”, “CORAL”, and “SEAWEED” symbols, a line winning is achieved when three, four, or all of five symbols of the same type are displayed on a payline. “WILD1”, “WILD2”, “WILD3”, and “WILD4” symbols substitute for “ORCA”, “DOLPHIN”, “TURTLE”, “CLOWN FISH”, “YELLOW FISH”, “WHITE FISH”, “BLUE FISH”, “STARFISH”, “CORAL”, and “SEAWEED” symbols.

The payout table shown in FIG. 8 is a table which defines a credit amount awarded when the normal game is executed with the betting of 50 credits which is the minimum betting amount. When the normal game is executed with the betting of credits other than 50, a credit amount to be awarded is determined in such a way that a multiplier is calculated by dividing a bet amount by 50 and an awarded credit amount shown in FIG. 8 is multiplied by the multiplier.

When three “ORCA” are arranged on one payline while the normal game is executed with the betting of 50 credits, 15 credits are awarded in response to the winning When five “ORCA” are arranged on one payline while the normal game is executed with the betting of 500 credits, 2500 (=250×10) credits are awarded in response to the winning Hereinafter, a multiplier calculated by dividing a bet amount by 50 will be referred to as “BET MULTIPLIER”.

When three or more “BONUS” symbols (specific symbols 502) which trigger the feature game are rearranged in the display window 150, a winning combination of the “feature game trigger” is achieved and the game shifts to the feature game. Specifically, the symbol of “BONUS” displayed on the first reel 101 to the fifth reel 105 may be rearranged in any of the upper stage, the upper middle state, the lower middle stage, and the lower stage of the display window (paylines do not matter). For example, when the “BONUS” is rearranged in the lower stage of the first reel 101, in the upper middle stage of the second reel 102, and in the upper stage of the third reel 103, this is regarded as to be a winning combination of the “feature game trigger”.

In the present embodiment, when three or more “BONUS” symbols are rearranged in the display window 150, a scattered winning of BONUS AWARD is achieved. When the normal game is executed with the betting of 50 credits, 100 credits are awarded if three “BONUS” symbols are rearranged, 250 credits are awarded if four “BONUS” symbols are rearranged, and 1000 credits are awarded if five “BONUS” symbols are rearranged.

[Feature Game]

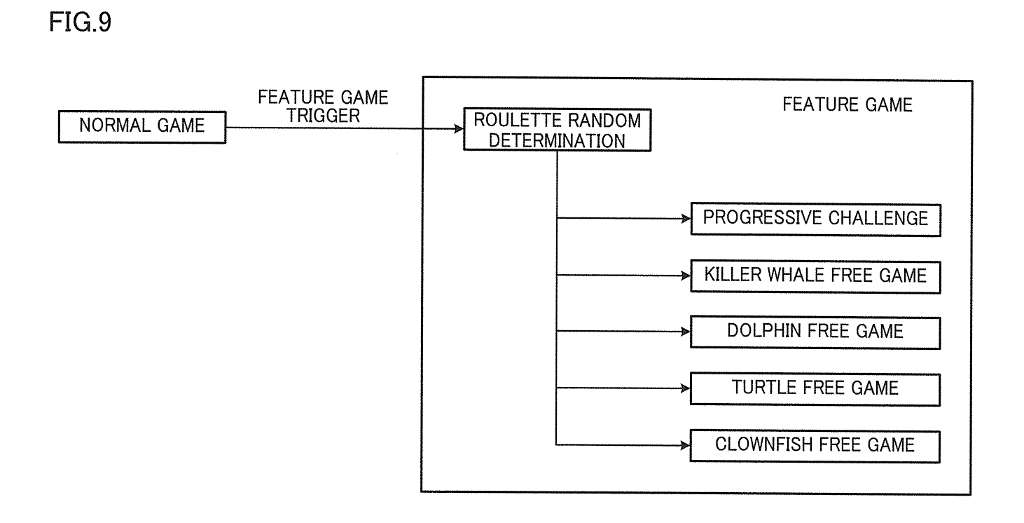

Now, referring to FIG. 9, the feature game will be described.

In the slot machine 1 of the present embodiment, when three or more “BONUS” symbols (specific symbols 502) are rearranged in the display window 150 in the normal game, the trigger condition is established and shifting to the feature game occurs. As shown in FIG. 9, this feature game is formed mainly of roulette random determination, progressive challenge, and four types of special games (Killer whale free game, Dolphin free game, Turtle free game, and Clownfish free game).

The progressive challenge is a game in which the free game is executed three times and one of the four types of the progressive jackpots is awarded as a prize in accordance with the game results of the free game. The free game is a slot game in which symbols 501 (see FIG. 6 or the like) are rearranged.

The special game is a game in which the free game of rearranging the symbols 501 is executed a predetermined number of times and a payout is awarded in accordance with a combination of the rearranged symbols.

The free game in the special game is executed without requiring the betting of a game value, but is different from the free game executed in the progressive challenge. As detailed later, for example, in the free game which is executed plural times in the progressive challenge, whether a winning is achieved is determined based solely on the total number of the specific symbols 502 rearranged in the free game which is executed plural times. On this account, in the progressive challenge, the payout amount is unchanged even if the combination of the symbols displayed on a payline is identical with a combination of the symbols defined in the payout table shown in FIG. 8. In the meanwhile, in the special game, whether a winning is achieved is determined based on the payout table in the same manner as in the normal game. Hereinafter, the progressive challenge and the four types of the special game will be correctively referred to as features.

[Roulette Random Determination]

The roulette random determination is performed to randomly select one of five features formed of the progressive challenge and the four types of the special games. In this roulette random determination, to begin with, a feature selection process of selecting one of the progressive challenge and the special game is carried out by using a feature selection table shown in FIG. 10A. The feature selection table is a table in which weight is allocated to each of the progressive challenge and the special game, for each bet amount bettable on the normal game. The weight indicates the probability of the selection of each of the progressive challenge and the special games in the feature selection process.

As described above, the “Bet Multiplier” in the feature selection table indicates a multiplier calculated by dividing each bet amount bettable on the normal game by 50. For example, in “Bet Multiplier”, “1” indicates that the bet amount in the normal game is 50, and “3” indicates that the bet amount in the normal game is 150. On this account, when, for example, the normal game is executed with the betting of 150 credits, the probability of the selection of the special game is 9333/10000 and the probability of the selection of the progressive challenge is 677/10000 in the feature selection process.

In the present embodiment, as shown in the feature selection table shown in FIG. 10A, as the bet amount bet on the normal game increases, the probability of the selection of the progressive challenge increases in the feature selection process.

In the present embodiment five types of the feature selection tables (see FIG. 10A to FIG. 10E) are provided in accordance with the five game settings SC1 to 5, and the AUDIT is arranged so that one of the five types of the feature selection tables is selectable. For each SC, seven types of the feature selection tables may be provided to correspond to the seven settings V01 to V07. To put it differently, 35 types of feature selection tables may be provided to correspond to the 35 types of game settings, respectively.

[Special Game Selection Table]

In the present embodiment, when the special game is selected in the feature selection process, a special game selection process of selecting one of four types of the special game is executed by using a special game selection table shown in FIG. 11. In the special game selection table, weight is set for each of the four types of the special game, i.e., “Killer whale free game”, “Dolphin free game”, “Turtle free game”, and “Clownfish free game”. The weight indicates the probability of the selection of each of the four types of the special game in the special game selection process. In the present embodiment, the weight of each of the four types of the special game is set at “1”, and hence the probability of the selection of each special game is 1/4.

[Roulette Display]

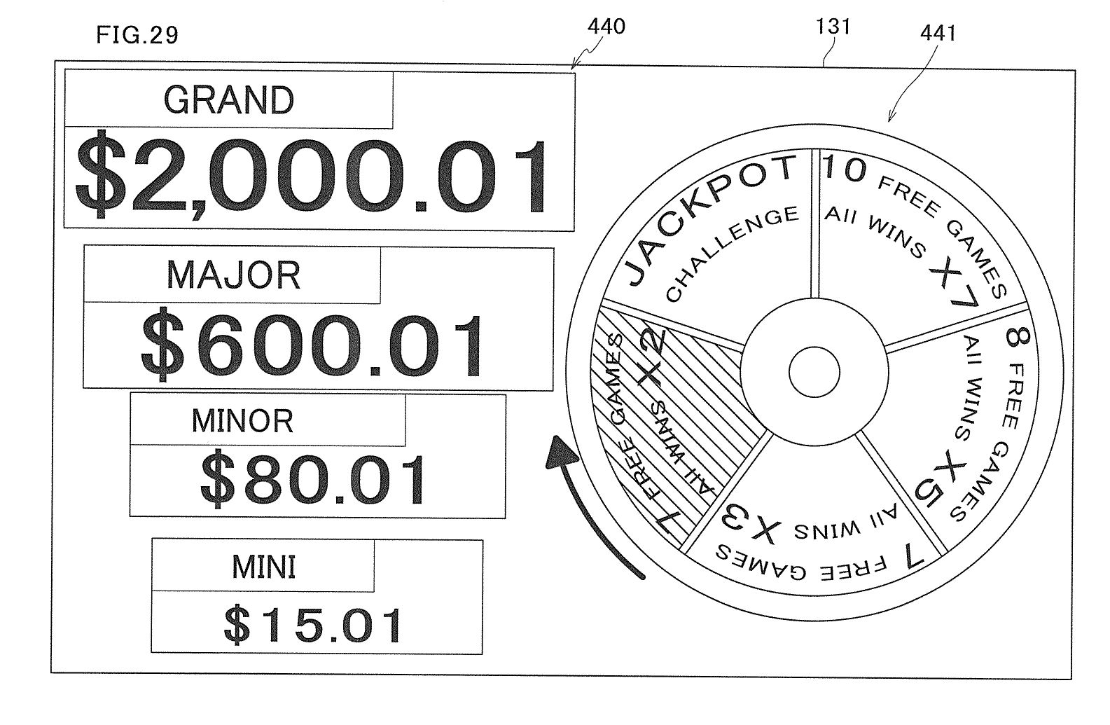

When the feature selection process and the special game selection process above are executed and one of the five features formed of the progressive challenge and the four types of the special games is selected, as shown in FIG. 29, on the upper image display panel 131, the five areas in the roulette 441 are lighted one by one and then the roulette 441 stops at the area corresponding to the selected feature. This allows the player who sees the upper image display panel 131 to recognize which one of the five features has been selected.

[Special Game]

Now, the special game will be described. As described above, in the special game, the free game of rearranging the symbols 501 is executed a predetermined number of times. When a combination of the symbols displayed on a payline in each execution of the free game corresponds to a combination of the symbols defined in the payout table, a value calculated by multiplying the credit amount defined in the payout table by a predetermined payout rate is awarded as a payout. The four types of the special games are different from one another in the payout rate and the number of times of execution of the free game to be awarded.

[Special Game Setting Table]

The special game setting table shown in FIG. 12 defines the payout rate and the number of times of execution of the free game to be awarded in each of the four types of the special game (“Killer whale free game”, “Dolphin free game”, “Turtle free game”, and “Clownfish free game”). In each special game, when a winning is achieved, a value calculated by multiplying an awarded credit amount which is defined in the payout table of FIG. 8 as a payout for that winning by (i) a multiplier (BET MULTIPLIER) and (ii) a payout rate is determined as a payout amount. For this reason, for example, when the shifting to the feature game occurs while the normal game is executed with the betting of 150 credits and the Killer whale free game is executed, 315 (=15×3×7) credits are awarded when three “ORCA” are arranged on a single payline. When the shifting to the feature game occurs while the normal game is executed with the betting of 100 credits and the “Dolphin free game” is executed, 200 (=20×2×5) credits are awarded when four “CORAL” are arranged on a single payline.

In the present embodiment, the payout rates of the “Killer whale free game”, “Dolphin free game”, “Turtle free game”, and “Clownfish free game” are in the descending order as shown in the special game setting table. The numbers of times of execution of the free game to be awarded are 10 in the “Killer whale free game”, 8 in the “Dolphin free game”, 7 in the “Turtle free game”, and 7 in the “Clownfish free game”. As mentioned above, in all the four types of the special games, the same special game symbol table (see FIG. 7) is used for determining the symbols to be rearranged in each special game. On this account, the probabilities of winning respective combinations of the symbols defined in the payout table of FIG. 8 are identical among the free games executed in the four types of the special game. The expectation on the credit amount to be awarded to the player is highest in the “Killer whale free game” in which the number of times of execution of the free game to be awarded and the payout rate are both largest, is second highest in the “Dolphin free game”, is third highest in the “Turtle free game”, and is fourth highest in the “Clownfish free game”. While in the present embodiment the symbols to be rearranged are determined by using the same special game symbol table in all four types of the special game, four types of special game symbol tables may be provided for the four types of the special games, respectively, and the symbols to be rearranged may be determined by using the corresponding special game symbol table in each special game.

[Progressive Challenge]

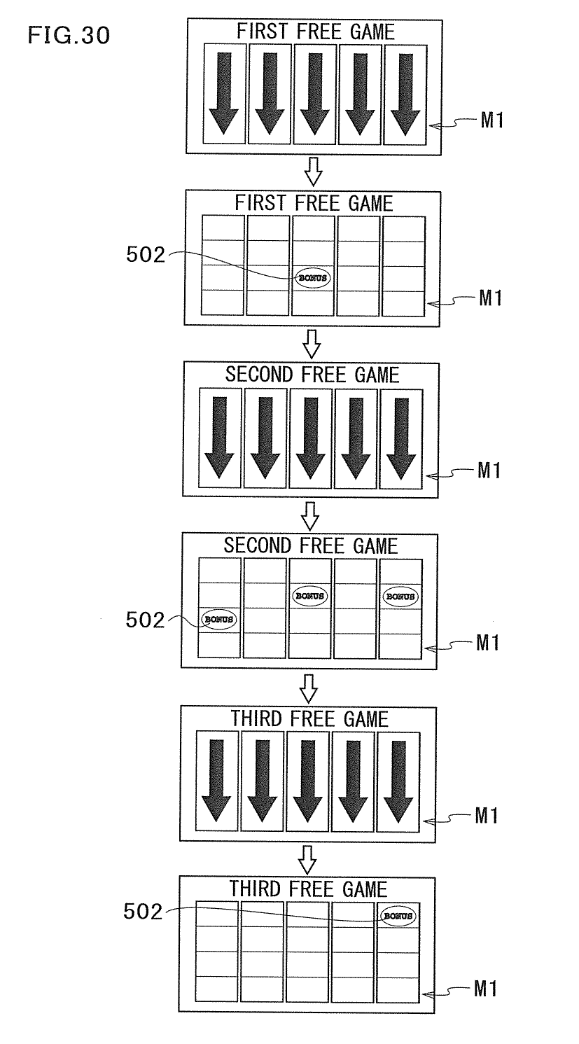

Now, the progressive challenge will be described. The progressive challenge is a game for determining which one of the four types of the progressive jackpots (“GRAND JACKPOT”, “MAJOR JACKPOT”, “MINOR JACKPOT”, and “MINI JACKPOT”) is to be awarded as a prize. In the progressive challenge, the free game is executed three times as shown in FIG. 30. In accordance with the total number of the specific symbols rearranged during the execution of the free game three times, one of the four types of the progressive jackpots is awarded as a prize.

While in the present embodiment there are four types of the progressive jackpots, the number of the types is not limited as long as the number is plural.

The payout amount of each of the four types of the progressive jackpots is a total sum of a progressive initial payout value and a value which is incremented with a predetermined rate (increment rate) of a bet amount bet on each execution of the normal game. The progressive initial payout and the increment rate corresponding to each of the four types of the progressive jackpots are defined in a special game setting table shown in FIG. 13.

[Progressive Payout Setting Table]

Now, the progressive payout setting table will be described with reference to FIG. 13. As shown in FIG. 13, the progressive initial payout values of the “GRAND JACKPOT”, “MAJOR JACKPOT” “MINOR JACKPOT” and “MINI JACKPOT” are in the descending order. For each of the four progressive jackpots, five types of progressive initial payout values are set in accordance with the five game settings SC1 to 5. As the AUDIT selects one of the five settings SC1 to 5, the progressive initial payout value of each of the four progressive payouts is changeable.

In each of the “GRAND JACKPOT”, “MAJOR JACKPOT”, “MINOR JACKPOT”, and “MINI JACKPOT”, 0.25% of the bet amount that the player bets on the normal game is incremented in each execution of the normal game and accumulated. This increment rate may be arranged to be settable by the AUDIT. In the present embodiment, the increment rates of the “GRAND JACKPOT”, “MAJOR JACKPOT”, “MINOR JACKPOT”, and “MINI JACKPOT” are all 0.25%. On this account, the value for the increment in each execution of the normal game remains the same irrespective of the level of the progressive jackpot. For this reason, in the present embodiment, the payout amounts (levels) of the “GRAND JACKPOT”, “MAJOR JACKPOT”, “MINOR JACKPOT”, and “MINI JACKPOT” are in the descending order as in the case of the progressive initial payout values. As a modification, the increment rates of the “GRAND JACKPOT”, “MAJOR JACKPOT”, “MINOR JACKPOT”, and the “MINI JACKPOT” may be in the ascending order.

For each of the “GRAND JACKPOT”, “MAJOR JACKPOT”, “MINOR JACKPOT”, and “MINI JACKPOT”, as shown in FIG. 13, the maximum number of the progressive payout is set.

[Progressive Level/number Table]

In the progressive challenge, the type of the progressive jackpot to be awarded is changed in accordance with the total number of the specific symbols 502 rearranged in the display window 150 in the execution of the free game three times. The progressive level/number table shown in FIG. 14 is a table in which the total number of the specific symbols 502 is associated with each type of the progressive jackpot.

In the present embodiment, there are 6 types, “3” to “8”, of the total numbers of the specific symbols 502 rearranged in the display window 150 in the execution of the free game three times. On this account, in the progressive level/number table, the six types of the total numbers of the specific symbols 502 are associated with the four types of progressive jackpot. In the present embodiment, as shown in FIG. 14, the “MINI JACKPOT” payout is awarded as a prize when the total number of the specific symbols 502 rearranged in the display window 150 in the execution of the free game three times is 3, the “MINOR JACKPOT” payout is awarded when the total number of the specific symbols 502 is 4 or 5, the “MAJOR JACKPOT” payout is awarded when the total number of the specific symbols 502 is 6 or 7, and the “GRAND JACKPOT” payout is awarded when the total number of the specific symbols 502 is 8. As described above, in the present embodiment, as the payout of the type of the progressive jackpot increases, the associated total number of the specific symbols increases. In the present embodiment, the progressive level/number table is equivalent to a first table.

[Number of Specific Symbol Determination Table]

Now, the number of specific symbol determination table shown in FIG. 15A will be described. This number of specific symbol determination table is used in the specific symbol number random determination process in which the total number of the specific symbols 502 rearranged in the display window 150 in the execution of the free game three times is randomly determined. As shown in FIG. 15A, the number of specific symbol determination table is a table in which, for each bet amount bettable on the normal game, a weight is set for each type of the total number of the specific symbols 502 which may be rearranged in the display window 150 in the execution of the free game three times. The weight indicates the probability of the selection of each type of the total number of the specific symbols 502 in the specific symbol number random determination process. The “Bet Multiplier” in the number of specific symbol determination table indicates, as described above, a multiplier calculated by dividing each bet amount bettable on the normal game by 50. On this account, for example, when the normal game is executed with the bet amount of 150 (Bet Multiplier=3), the probability of the selection of “3” as the total number of the specific symbols 502 in the specific symbol number random determination process is 64/200, whereas the probability of the selection of “4” is 34/200.

In the present embodiment, as shown in the number of specific symbol determination table in FIG. 15A, as the bet amount bet on the normal game increases, the probability (selection rate) of the selection of a large total number of the specific symbols increases in the specific symbol number random determination process. To put it differently, as the bet amount bet on the normal game increases, the expectation on a winning of the progressive jackpot with a large payout in the progressive challenge increases. As a result, when shifting to the progressive challenge occurs while the bet amount bet on the normal game is large, the player expects a winning of the progressive jackpot with a large payout. In the present embodiment, the number of specific symbol determination table is equivalent to a fourth table.

35 types of the number of specific symbol determination tables are provided to correspond to the 35 types of game settings, and the AUDIT is arranged so that one of these 35 types of the number of specific symbol determination tables is selectable. In the present embodiment, the feature selection tables corresponding to the seven settings V01 to V07 are identical with one another in each SC. FIG. 15A to FIG. 15E show the feature selection tables set for each SC.

[Free Game Allocation Pattern Determination Table]

Now, six types of free game allocation pattern determination tables shown in FIG. 16A to FIG. 16F will be described. These free game allocation pattern determination tables are used for a free game allocation process in which how the number of the specific symbols 502 is allocated to each of the three times of the execution of the free game is determined. Each of the six types of the free game allocation pattern determination tables is associated with one of the six types of the total numbers of the specific symbols 502 selectable in the specific symbol number random determination process. To be more specific, for example, when the total number of the specific symbols 502 determined in the specific symbol number random determination process is “3”, a 3-symbol free game allocation pattern determination table shown in FIG. 16A is used in the free game allocation process. When the determined total number of the specific symbols 502 is “4”, a 4-symbol free game allocation pattern determination table shown in FIG. 16B is used in the free game allocation process. When the determined total number of the specific symbols 502 is “5”, a 5-symbol free game allocation pattern determination table shown in FIG. 16C is used in the free game allocation process. When the determined total number of the specific symbols 502 is “6”, a 6-symbol free game allocation pattern determination table shown in FIG. 16D is used in the free game allocation process. When the determined total number of the specific symbols 502 is “7”, a 7-symbol free game allocation pattern determination table shown in FIG. 16E is used in the free game allocation process. When the determined total number of the specific symbols 502 is “8”, a 8-symbol free game allocation pattern determination table shown in FIG. 16E is used in the free game allocation process.

Each of the six types of the free game allocation pattern determination tables has plural allocation patterns each defining the number of the specific symbols 502 allocated to each execution of the free game. For example, the 3-symbol free game allocation pattern determination table shown in FIG. 16A has ten allocation patterns corresponding to the code numbers “10” to “19”. In this 3-symbol free game allocation pattern determination table, for example, the allocation pattern with the code number “14” indicates that one specific symbol 502 is rearranged in the display window 150 in the first execution of the free game, zero specific symbol 502 is rearranged in the display window 150 in the second execution of the free game, and two specific symbols 502 are rearranged in the display window 150 in the third execution of the free game. The allocation pattern with the code number “19” indicates that three specific symbols 502 are rearranged in the display window 150 in the first execution of the free game and zero specific symbol 502 is rearranged in the display window 150 in the second and third execution of the free game.

For each of the allocation patterns of each free game allocation pattern determination table, a weight is set. This weight indicates the probability of the selection of the corresponding allocation pattern in the free game allocation process. In other words, the probability of the selection of the corresponding allocation pattern in the free game allocation process is calculated by dividing the weight of that allocation pattern by the total weight of the all allocation patterns.

In the arrangement above, for example, when the total number of the specific symbols 502 determined in the specific symbol number random determination process is “3”, the probability of the selection of the allocation pattern having the code number “14” in the 3-symbol free game allocation pattern determination table shown in FIG. 16A is 1/6 in the free game allocation process. Similarly, for example, when the total number of the specific symbols 502 determined in the specific symbol number random determination process is “5”, the probability of the selection of the allocation pattern having the code number “44” in the 5-symbol free game allocation pattern determination table shown in FIG. 16C is 1/15 in the special game selection process.

As described above, the number of the specific symbols 502 allocated to each execution of the free game is determined by an allocation pattern which is randomly selected from the predetermined number of the allocation patterns. This diversifies the rearrangement patterns of the specific symbols 502 rearranged in the display window 150 in the execution of the free game plural times. In other words, effect patterns of the effect of indicating which one of the plural types of progressive payouts is won are diversified. In the present embodiment, this free game allocation pattern determination table is equivalent to a second table.

[Reel Allocation Pattern Determination Table]

Now, six types of reel allocation pattern determination tables shown in FIG. 17A to FIG. 17F will be described. These reel allocation pattern determination tables are used in the reel allocation process of determining the number of the specific symbols 502 allocated to each of the reels (reel 101 to 105) in each execution of the free game. Each of the six types of the reel allocation pattern determination tables is associated with one of the six types of the numbers of the specific symbols 502 allocated to each execution of the free game in the free game allocation process (i.e., six types of the numbers of the specific symbols which may be rearranged in one execution of the free game). To be more specific, for example, when the number of the specific symbols 502 allocated in the free game allocation process is “0”, a 0-symbol reel allocation pattern determination table shown in FIG. 17A is used in the reel allocation process. When the number of the allocated specific symbols 502 is “1”, a 1-symbol reel allocation pattern determination table shown in FIG. 17B is used in the reel allocation process. When the number of the allocated specific symbols 502 is “2”, a 2-symbol reel allocation pattern determination table shown in FIG. 17C is used in the reel allocation process. When the number of the allocated specific symbols 502 is “3”, a 3-symbol reel allocation pattern determination table shown in FIG. 17D is used in the reel allocation process. When the number of the allocated specific symbols 502 is “4”, a 4-symbol reel allocation pattern determination table shown in FIG. 17E is used in the reel allocation process. When the number of the allocated specific symbols 502 is “5”, a 5-symbol reel allocation pattern determination table shown in FIG. 17E is used in the reel allocation process.

Each of the six types of the reel allocation pattern determination tables has a predetermined number of allocation patterns each specifying the number of the specific symbols 502 allocated to each reel. For example, the 2-symbol reel allocation pattern determination table shown in FIG. 17C has ten allocation patterns corresponding to the code numbers “6” to “15”. In this 2-symbol reel allocation pattern determination table, for example, the allocation pattern with the code number “6” indicates that no specific symbol 502 is rearranged (displayed) on the reel 101 to 103 and one specific symbol 502 is rearranged on the reels 104 and 105. The allocation pattern with the code number “14” indicates that no specific symbol 502 is rearranged on the reels 102, 104, and 105 and one specific symbol 502 is rearranged on the reels 101 and 103.

For each of the predetermined number of allocation patterns of each reel allocation pattern determination table, a weight is set. This weight indicates the probability of the selection of the corresponding allocation pattern in the reel allocation process. That is to say, the probability of the selection of the corresponding allocation pattern in the reel allocation process is calculated by dividing the weight of that allocation pattern by the total weight of the all allocation patterns.

In the 1-symbol reel allocation pattern determination table (see FIG. 17B), the 2-symbol reel allocation pattern determination table (see FIG. 17C), the 3-symbol reel allocation pattern determination table (see FIG. 17D), and the 4-symbol reel allocation pattern determination table (see FIG. 17E), there are two types (Type A and Type B) of the weights set for each allocation pattern. In the 1-symbol reel allocation pattern determination table (see FIG. 17B), Type A is used in the reel allocation process of the third execution of the free game when the total number of the specific symbols 502 rearranged until the end of the second execution of the free game is 2, 4, or 6, whereas Type B is used in cases other than this. Therefore, when, for example, the total number of the specific symbols 502 to be rearranged in the display window 150 in the execution of the free game three times is 7 in the specific symbol number random determination process, Type A is used when the total number of the specific symbols 502 rearranged until the end of the second execution of the free game is 6. When the Type A is used, the probability of the selection of the allocation pattern with the code number “5” is 1/2 in the reel allocation process. In the meanwhile, when the Type B is used, the probability of the selection of the allocation pattern with the code number “5” is 2/15 in the reel allocation process.

Similarly, in the 2-symbol reel allocation pattern determination table (see FIG. 17C), Type A is used in the reel allocation process of the third execution of the free game when the total number of the specific symbols 502 rearranged until the end of the second execution of the free game is 1, 3, or 5, whereas Type B is used in cases other than this. In the 3-symbol reel allocation pattern determination table (see FIG. 17D), the Type A is used in the reel allocation process of the third execution of the free game when the total number of the specific symbols 502 rearranged until the end of the second execution of the free game is 0, 2, or 4, whereas Type B is used in cases other than this. In the 4-symbol reel allocation pattern determination table (see FIG. 17E), Type A is used in the reel allocation process of the third execution of the free game when the total number of the specific symbols 502 rearranged until the end of the second execution of the free game is 1 or 3, whereas Type B is used in cases other than this.

As described above, the number of the specific symbols 502 allocated to each of the reels 101 to 105 in each execution of the free game is determined based on the allocation pattern randomly selected from the predetermined number of the allocation patterns. This diversifies the rearrangement patterns of the specific symbols rearranged on the display device in each execution of the free game. That is to say, the effect patterns of the effect of indicating which one of the plural types of progressive payouts is won are further diversified. In the present embodiment, this reel allocation pattern determination table is equivalent to a third table.

[Stop Position Determination Table]

Now, two types of stop position determination tables shown in FIG. 18A and FIG. 18B will be described.

These stop position determination tables are used for a stop position determination process of determining the stop position of each of the reels (reels 101 to 105) in each execution of the free game. Each of these two types of the stop position determination tables is associated with the number of the specific symbols 502 of one of the two types, which may be allocated to one reel in the reel allocation process. To be more specific, when the number of the specific symbols allocated to one reel in the reel allocation process is “1”, a 1-symbol stop position determination table shown in FIG. 18A is used. When the number of the specific symbols is “0”, a 0-symbol stop position determination table shown in FIG. 18B is used.

In the present embodiment, because the code number corresponding to the specific symbol 502 is “13” as shown in FIG. 4, the symbols to be stopped in the upper middle stage of the display window 150 have four code numbers “11” to “14” when one specific symbol 502 is rearranged on each of the reels 101 to 105.

In the 1-symbol stop position determination table shown in FIG. 18A, for each reel, the four code numbers and a weight set for each of the code numbers are defined. The weight indicates the probability of the rearrangement of the corresponding symbol 501 in the upper middle stage of the display window 150. That is to say, the probability of the rearrangement of the corresponding symbol 501 in the upper middle stage of the display window 150 is calculated by dividing the weight of the code number of that symbol by the total weight of the four code numbers “11” to “14”. On this account, when, for example, one specific symbol 502 is rearranged on the reel 101, the probability of the rearrangement of the symbol with the code number “13” in the upper middle stage of the display window 150 is 1/4.

In the present embodiment, when no specific symbol 502 is rearranged on each of the reels 101 to 105, the code numbers of the symbols to be stopped in the upper middle stage of the display window 150 are “10” and “15”. In the 0-symbol stop position determination table shown in FIG. 18B, for each of the reels 101 to 105, the two code numbers and a weight set for each of these code numbers are defined. The weight indicates the probability of the rearrangement of the corresponding symbol 501 in the upper middle stage of the display window 150. That is to say, the probability of the rearrangement of the corresponding symbol 501 in the upper middle stage of the display window 150 is calculated by dividing the weight of the code number of that symbol by the total weight of the two code numbers “10” and “15”. On this account, when, for example, no specific symbol 502 is rearranged on the reel 102, the probability of the rearrangement of the symbol with the code number “15” in the upper middle stage of the display window 150 is 1/2.

As described above, in the present embodiment, the effect of indicating which one of the plural types of progressive jackpot is to be awarded as a prize is performed by displaying the specific symbol 502 in the display window 150 during the execution of the free game plural times. As such, as the symbols on the reel unit M1 displaying a game result in the normal game are used for the effect of indicating which one of the plural types of progressive payouts is awarded as a prize, the effect is achieved with a simple arrangement. While in the present embodiment the specific symbols 502 are displayed stepwise on the reel unit M1 by executing the free game of rearranging the symbols on the reel unit M1 plural times, the disclosure is not limited to this arrangement on condition that the specific symbols 502 are displayed stepwise on the reel unit M1. For example, instead of the execution of the free game plural times, a game executed on condition that a game value is bet may be executed plural times, and the specific symbols 502 may be displayed stepwise on the reel unit M1 during the execution of the game plural times.

In this regard, when the free game in the progressive challenge is arranged in the same manner as the a normal game above such that symbols to be rearranged are randomly determined and the determined symbols are rearranged in the display window 150, because the total number of the specific symbols 502 rearranged during the execution of the free game plural times is determined based on the random determination of the symbols to be rearranged in each execution of the free game, it is difficult to control the total number of the specific symbols 502.

In the meanwhile, in the progressive challenge of the present embodiment, after the total number of the specific symbols 502 to be rearranged in the display window 150 in the execution of the free game three times is randomly determined, symbols to be rearranged on the display window 150 in each execution of the free game is determined based on the random determination result. As such, because in the present embodiment the total number of the specific symbols 502 to be rearranged in the execution of the free game plural times is determined by single random determination, it is easy to control the total number of the specific symbols 502. To put it differently, in the present embodiment, the probability of winning each of the plural types of progressive jackpot is easily adjustable, and hence the payout rate of the slot machine 1 is easily adjustable.

[Contents of Program]

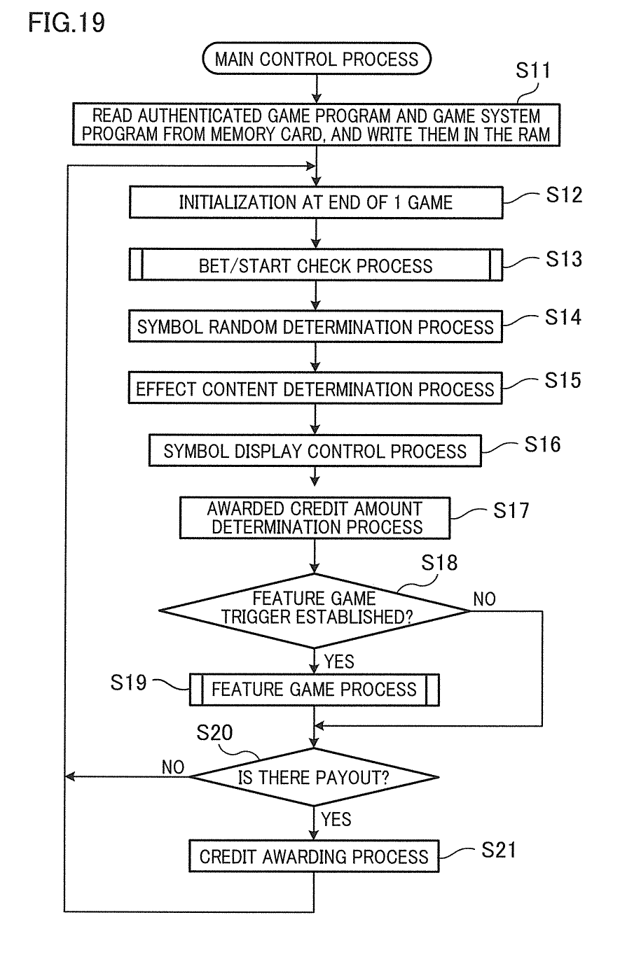

Now, the program to be executed by the slot machine 1 is described with reference to FIGS. 19 to 24.

(Main Control Process)

First, with reference to FIG. 19, a main control process is described.

First, when the slot machine 1 is powered on, the main CPU 71 reads the authenticated game program from the memory card 54 through the gaming board 50, and writes the program into the RAM 73 (S11).

Next, the main CPU 71 executes at-one-game-end initialization process (S12). This process clears data in a working area of the RAM 73, which becomes unnecessary at the end of each round of game, e.g., a bet amount, symbols randomly determined, and the like.

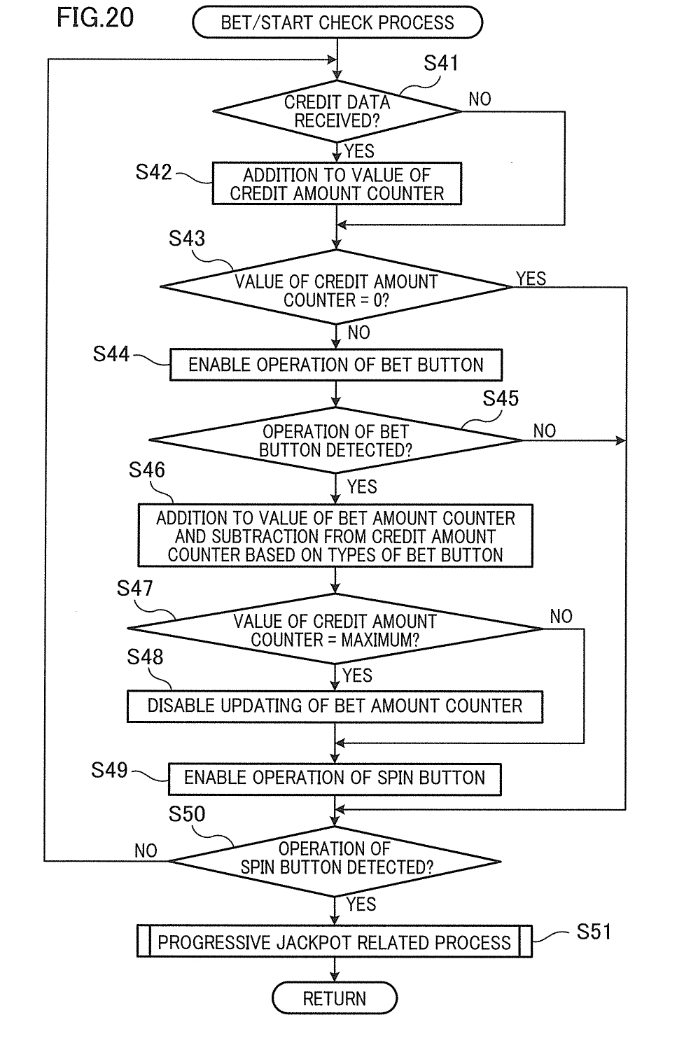

The main CPU 71 executes a bet/start check process which is described later with reference to FIG. 20 (S13). In this process, an input check or the like is executed for the 50-BET switch 34S, the 100-BET switch 35S, the 150-BET switch 36S, the 250-BET switch 37S, the 500-BET switch 38S, and the spin switch 46S.

The main CPU 71 then executes a symbol random determination process (S14). In the process, to-be-stopped symbols are determined based on the random numbers for symbol determination. In the present embodiment, symbols to be stopped on each of the reels 101 to 105 are determined according to the weight values of the 22 symbols corresponding to code numbers 00 to 21, shown in FIG. 6.

The main CPU 71 then executes an effect contents determination process (S15). The main CPU 71 samples an effect-use random number, and randomly selects any of the effect contents from the preset plurality of effect contents.

Next, the main CPU 71 executes the symbol display control process (S16). In this process, scrolling of the reels 101 to 105 is started, and the symbols to be stopped, which are determined in the symbol random determination process of S14, are stopped in predetermined positions (e.g., the upper middle stage of the display windows 150). That is, 20 symbols including the to-be-stopped symbols are displayed in the display windows 150. In this symbol display control process, the effect determined in the effect contents determination process in the step S15 is executed.

Subsequently, the main CPU 71 executes the awarded credit amount determination process (S17). In this process, the payout table (see FIG. 8) stored in the RAM 73 is referred to, and the awarded credit amount is determined based on a combination of the symbols displayed on the payline, and the credit amount thus determined is stored in the awarded credit amount storage area in the RAM 73.

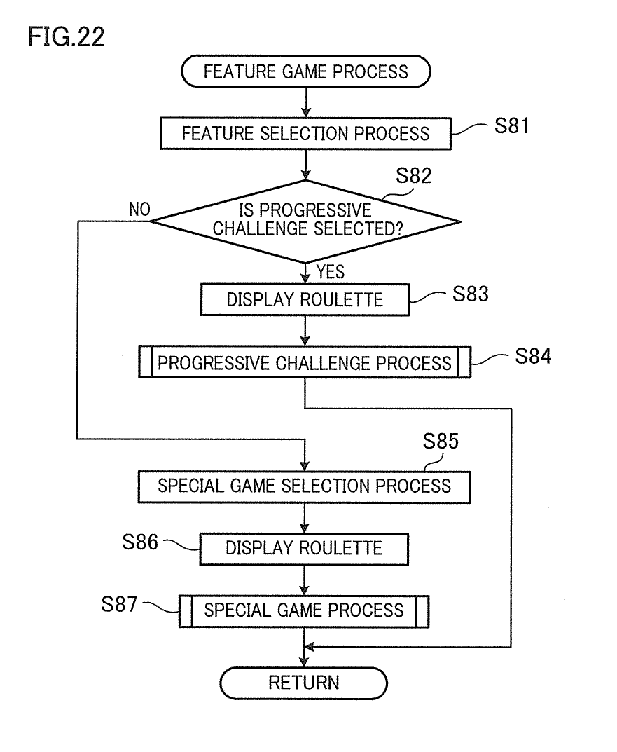

Subsequently, the main CPU 71 determines whether the feature game trigger has been established (S18). In the present embodiment, as shown in FIG. 25, when three or more “BONUS” symbols (specific symbols 502) which are the trigger symbols of the feature game are rearranged on the display window 150, the “feature game trigger” is selected as a winning combination and the shifting to the feature game occurs. When the feature game trigger has been established (S18: YES), the main CPU 71 executes the feature game process which will be described with reference to FIG. 22 (S19).

Thereafter, after the step S19 or when it is determined in the step S18 that the feature game trigger is not established (S18: NO), the main CPU 71 determines whether there is a payout (S20). That is to say, whether a payout has been awarded in S17 or S19 is determined. When there is a payout (S20: YES), a credit awarding process is executed (step S21). The main CPU 71 adds the value stored in the awarded credit amount storage area to the value stored in the credit amount storage area provided in the RAM 73. Alternatively, based on an input to the CASHOUT switch 32S, the main CPU 71 may control the PTS device 700 and write the credit data indicating the value stored in the awarded credit amount storage area into the IC card inserted into the card insertion slot. After this process or when it is determined in S20 that there is no payout (S20: NO), the process proceeds to the step S12.

(Bet/Start Check Process)

Next, with reference to FIG. 20, the bet/start check process is described.

To begin with, the main CPU 71 determines whether credit data is received from the PTS device 700 (S41). The credit data is sent from the PTS device 700 to the main CPU 71 when the IC card is inserted into the card insertion slot and when the bill entry 60 receives a genuine bill.

When the credit data is received (S41: YES), the main CPU 71 adds the amount indicated by the received credit data to the value stored in the credit amount storage area (S42).

After S42 or when determining in S41 that the receiving of the credit data has not been detected (S41: NO), the main CPU 71 determines whether or not the value stored in the credit amount storage area is zero (S43). When the main CPU 71 determines that the value stored in the credit amount storage area is not zero (S43: NO), the main CPU 71 permits operation acceptance of the bet buttons (50-bet button 34, 100-bet button 35, 150-bet button 37, 250-bet button 38, and 500-bet button 39) (S44).

Next, the main CPU 71 determines whether or not operation of any of the BET buttons has been detected (S45). When an operation of the bet button by a player is detected by the bet switch (50-bet switch 34S, 100-bet switch 35S, 150-bet switch 36S, 250-bet switch 37S, and 500-bet switch 38S), the main CPU 71 performs addition to the value stored in a bet amount storage area provided to the RAM 73, and performs reduction from the value stored in the credit amount storage area, based on the type of the bet button (S46).

The main CPU 71 then determines whether or not the value stored in the bet amount storage area is at its maximum (S47). The main CPU 71, when determining that the value stored in the bet amount storage area is the maximum value (S47: YES), prohibits updating of the value stored in the bet amount storage area (S48). After S48 or when determining in S47 that the value stored in the bet amount storage area is not at its maximum (S47: NO), the main CPU 71 permits operation acceptance of the spin button 46 (S49).

After S49, when determining in S45 that the operation of any of the BET buttons has not been detected (S45: NO), or when determining in S43 that the value stored in the credit amount storage area is zero (S43: YES), the main CPU 71 determines whether or not an operation of the spin button 46 has been detected (S50). The main CPU 71 shifts the process to S41, when determining that no operation of the spin button 46 is detected (S50: NO).

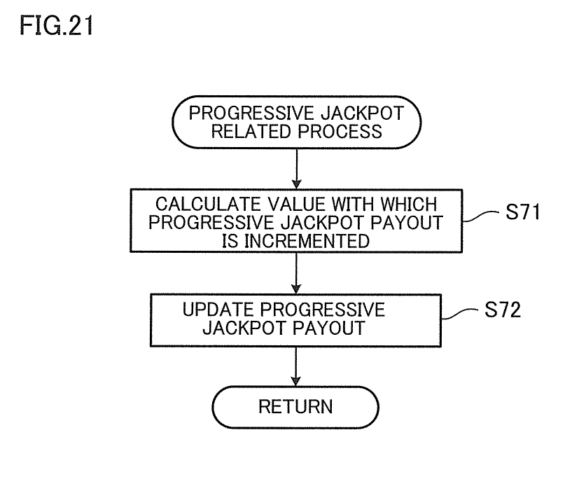

When it is determined that the operation of the spin button 46 is detected (S50: YES), the main CPU 71 executes the progressive jackpot related process which will be described later with reference to FIG. 21 (S51). In this process, the payout amounts of the four types of progressive jackpot are incremented with a part of the bet amount bet on the normal game, and the part is accumulated. In the present embodiment, a value with which each of the four types of progressive jackpot payout is incremented is calculated, and the payout amount of each of the four types of progressive jackpot, which is stored in a progressive payout storage area in the RAM 73, is updated. Then the bet/start check process is terminated.

(Progressive Jackpot Related Process)

Now, a progressive jackpot related process will be described with reference to FIG. 21.

To begin with, the main CPU 71 calculates the value with which each of the four types of the progressive jackpot payout amounts is incremented (S71). To be more specific, the main CPU 71 calculates a product of the value of the bet amount counter and an increment rate shown in FIG. 12 to determine a value with which each of the progressive jackpot payout amounts of the four types is incremented. For example, when the bet amount counter indicates “100”, the value with which the payout amount of each of the four types of progressive jackpot is incremented is 100×0.0025 (0.25%) =0.25.

Subsequently, the main CPU 71 accumulatively adds the value for the increment calculated in the step S71 to the payout amount of each of the four types of progressive jackpot stored in the progressive payout storage area in the RAM 73 and updates the payout amount (S72). After this step, the progressive jackpot related process is terminated.

(Feature Game Process)

Now, referring to FIG. 22, a feature game process will be described. FIG. 22 is a flowchart of a feature game process of the slot machine of the embodiment of the present invention.

To begin with, when the feature game process is executed, the main CPU 71 executes the feature selection process (S81). In this feature selection process, the main CPU 71 samples one random number. Then, with reference to the feature selection table (see FIG. 10A to FIG. 10E), one of the progressive challenge and the special game is randomly selected with reference to the weight of the bet amount of the bet on the normal game and the sampled random number. In other words, the winning condition of one of the progressive challenge and the special game is established.

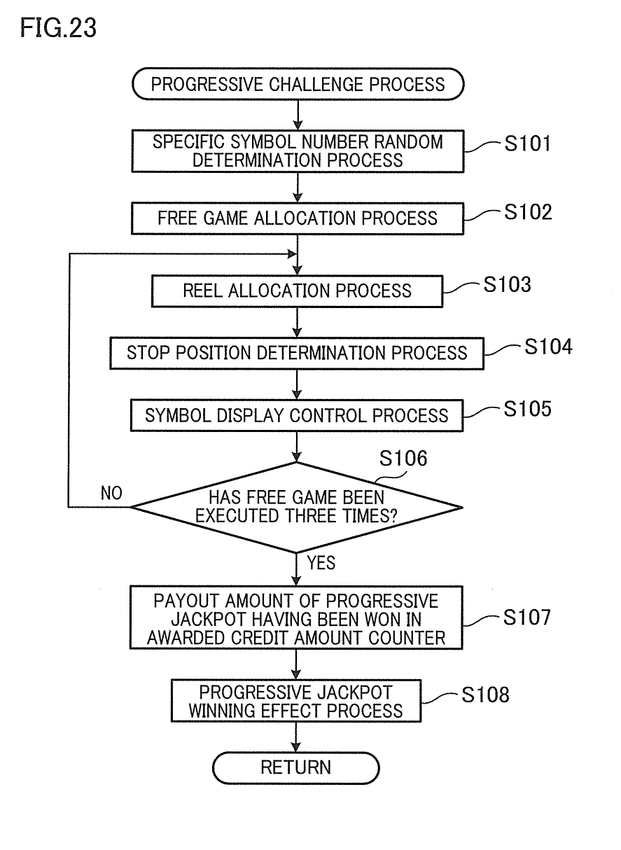

Subsequently, the main CPU 71 determines whether the progressive challenge has been selected in the step S81 (S82). When the progressive challenge is selected (S82: YES), it is determined that the winning condition of the progressive challenge has been established, and the main CPU 71 performs, on the upper image display panel 131, an effect of lighting the five areas of the roulette 441 one by one and then stopping the roulette 441 at the area corresponding to the progressive challenge (S83). Then the main CPU 71 executes the progressive challenge process which will be described later with reference to FIG. 23 (S84). The feature game process is then terminated after this step.

In the meanwhile, if the progressive challenge is not selected in the step S82 (S82: NO), the special game selection process is executed (S85). In this special game selection process, the main CPU 71 samples one random number. With reference to the special game selection table (see FIG. 11), one of the four types of special game is randomly selected based on the sampled random number.

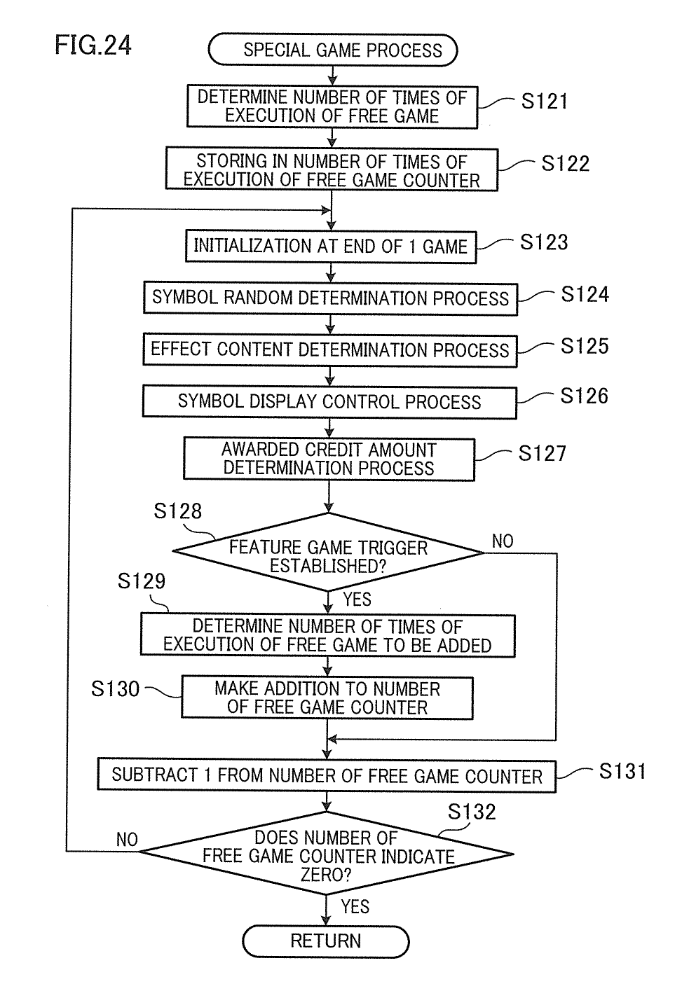

Subsequently, the main CPU 71 performs, on the upper image display panel 131, an effect of lighting the five areas of the roulette 441 one by one and then stopping the roulette 441 at the area corresponding to the type of the special game determined in the step S85 (S86). Then the main CPU 71 executes the special game process which will be described later with reference to FIG. 24 (S87). The feature game process is then terminated.

As described above, in the present embodiment, when three or more specific symbols 502 are rearranged in the display window 150 in the normal game and the shifting to the feature game occurs, one of the five features constituted by the progressive challenge and the four types of special game is awarded to the player as a prize. As such, in the slot machine 1 of the present embodiment, a prize awarded at the time of the shifting to the feature game is diversified.

(Progressive Challenge Process)

Now, the progressive challenge process will be described with reference to FIG. 23. FIG. 23 is a flowchart of the progressive challenge process in the slot machine of the embodiment of the present invention.

To begin with, when the progressive challenge process is executed, the main CPU 71 executes the specific symbol number random determination process (S101). To be more specific, in this specific symbol number random determination process, the main CPU 71 samples one random number. Thereafter, with reference to the number of specific symbol determination table shown in FIG. 15A, the total number of the specific symbols 502 to be rearranged in the display window 150 in the execution of the free game three times is randomly determined based on the weight of each of the types of the total numbers of the specific symbols 502 associated with the bet amount bet on the immediately preceding execution of the normal game and the sampled random number.

Subsequently, the main CPU 71 executes the free game allocation process (S102). To be more specific, in this free game allocation process, the main CPU 71 samples one random number. Then, with reference to the free game allocation pattern determination table associated with the total number of the specific symbols 502 determined in the specific symbol number random determination process in the step S101, one allocation pattern is randomly selected based on the weight set for each allocation pattern in the free game allocation pattern determination table and the sampled random number. As such, the number of the specific symbols 502 allocated to each of the three times of the execution of the free game is determined.

Subsequently, the main CPU 71 executes the reel allocation process (S103). To be more specific, in this reel allocation process, the main CPU 71 samples one random number. Then, with reference to the reel allocation pattern determination table associated with the number of the specific symbols 502 allocated to the free game and determined in the free game allocation process in the step S102, one allocation pattern is randomly selected based on the weight set for each allocation pattern and the sample random number. With this, as a result of single execution of the free game, the number of the specific symbols 502 allocated to each of the reels 101 to 105 is determined.

Subsequently, the main CPU 71 executes the stop position determination process (S104). To be more specific, in this stop position determination process, the main CPU 71 samples five random numbers corresponding to the reels 101 to 105, respectively. Then the stop position determination table corresponding to the number of the specific symbols 502 allocated to each of the reels 101 to 105 and determined in the reel allocation process in the step S103 is referred to. Based on the weight set for each code number in the referred stop position determination table and the sampled random number, symbols to be stopped are randomly determined. As this random determination of the to-be-stopped symbols is performed for each of the reels 101 to 105, the symbols 501 to be rearranged in the display window 150 are determined.

Next, the main CPU 71 executes the symbol display control process (S105). In this process, the scroll of the reels 101 to 105 starts, and the to-be-stopped symbols determined in the stop position determination process in the step S104 stop in the upper middle stage of the display window 150. That is, 20 symbols including five to-be-stopped symbols are displayed on the display windows 150.

Subsequently, the main CPU 71 determines whether the free game has been executed three times (S106). When the free game has not been executed three times (S106: NO), the process goes back to the step S103 to perform the next execution of the free game. In the meanwhile, when the free game has been executed three times (S106: YES), the main CPU 71 selects, as the progressive jackpot, the progressive jackpot associated with the total number of the specific symbols determined in the specific symbol number random determination process in the step S101 with reference to the progressive level/number table in FIG. 14, and the payout amount of the selected progressive jackpot is added to the value stored in the awarded credit amount storage area (S107). In other words, in the progressive payout storage area in the RAM 73, the payout amount of the selected progressive jackpot is added to the value stored in the awarded credit amount storage area. Furthermore, after this step S107, the payout amounts of the four types of progressive jackpots stored in the progressive payout storage area in the RAM 73 are initialized to a progressive initial payout value (see FIG. 13). As a modification, after the step S107, only the payout amount of the selected progressive jackpot among the payout amounts of the four types of progressive jackpot stored in the progressive payout storage area in the RAM 73 may be initialized to the progressive initial payout value.

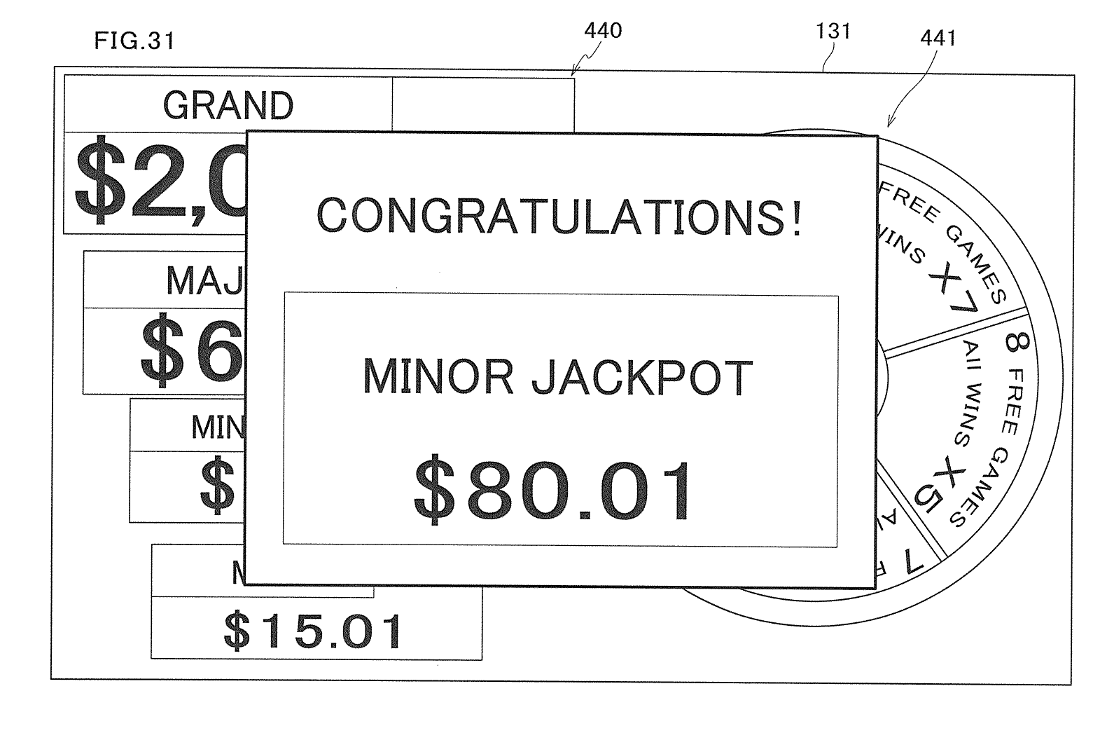

Subsequently, the main CPU 71 executes the progressive jackpot winning effect process (S108). In this process, as shown in FIG. 31, a message indicating that the jackpot payout is won, the payout amount of the obtained progressive jackpot, and the like are displayed on the upper image display panel 131. After this process, the progressive challenge process is terminated.

As described above, in the present embodiment, the symbols on the display device are utilized for displaying a game result in the normal game of awarding a prize in accordance with rearranged symbols and for an effect of indicating which one of the plural types of progressive payouts is to be awarded as a prize.

(Special Game Process)

Now, the special game process will be described with reference to FIG. 24. It should be noted that in the special game of the present embodiment, a slot game is run as in the normal game.

To begin with, the main CPU 71 determines, as the number of times of execution of the free game to be executed, the number of times of execution of the free game associated in the special game setting table shown in FIG. 12 with the type of the special game determined in the special game selection process (S121), and stores the number in the number of times of execution of free game counter in the RAM 73 (S122).

Next, the main CPU 71 executes an at-one-game-end initialization process (S123). This process clears data in a working area of the RAM 73, which becomes unnecessary at the end of each round of game, e.g., symbols randomly determined, and the like.

Subsequently, the main CPU 71 executes the symbol random determination process (S124). In the process, to-be-stopped symbols are determined based on the random numbers for symbol determination. In the present embodiment, symbols to be stopped on each of the reels 101 to 105 are determined according to the weight values of the 22 symbols corresponding to code numbers 00 to 21, shown in FIG. 7.

The main CPU 71 then executes an effect contents determination process (S125). The main CPU 71 samples an effect-use random number, and randomly selects any of the effect contents from the preset plurality of effect contents.

Next, the main CPU 71 executes the symbol display control process (S126). In this process, scrolling of the reels 101 to 105 is started, and the to-be-stopped symbols, which are determined in the symbol random determination process of S124, are stopped in predetermined positions (e.g., in the upper middle stage of the display windows 150). That is, 20 symbols including the to-be-stopped symbols are displayed on the display windows 150.

Subsequently, the main CPU 71 executes the awarded credit amount determination process (S127). In this process, with reference to the special game setting table (see FIG. 12) and the payout table (see FIG. 8), an awarded credit amount is determined based on a combination of symbols displayed on an activated payline, and the awarded credit amount is stored in the awarded credit amount storage area in the RAM 73.

Next, the main CPU 71 determines whether or not a re-trigger has been established (step S128). In the present embodiment, when three or more “BONUS” symbols (specific symbol 502) which are re-trigger symbols of the free game are rearranged in the display window 150, the “re-trigger” is selected as a winning combination.

When the re-trigger is established (S128: YES), the main CPU 71 determines the number of times of execution of the free game to be added (S129). In the present embodiment, the number of times of execution of the free game associated in the special game setting table shown in FIG. 12 with the type of the special game determined in the special game selection process above is selected as the number of times of execution of the free game to be added. The main CPU 71 then adds the selected number of times of execution of the free game to the number of times of execution of free game counter in the RAM 73 and updates the counter (S130).

Subsequently, after the step S130 or when the re-trigger is not established in the step S128 (S128: NO), the main CPU 71 subtracts 1 from the number of times of execution of free game counter in the RAM 73 and updates the counter (S131).

Subsequently, the main CPU 71 determines whether the number indicated by the number of times of execution of free game counter updated in the step S131 is larger than 0 (S132). When the number of times of execution of free game counter is larger than 0 (S132: YES), the process proceeds to the step S123.

In the meanwhile, when the number of times of execution of free game counter is not larger than 0 (S132: NO), the process is terminated.

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

Further, the detailed description above is mainly focused on characteristics of the present invention to fore the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the invention described in the present specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process executed in or by respective steps yielding one result or blocks with a predetermined processing function described in the present specification shall be understood as a process with no self-contradiction. Further, the electrical or magnetic signal is transmitted/received and written in the respective steps. It should be noted that such a signal is expressed in the form of bit, value, symbol, text, terms, number, or the like solely for the sake of convenience. Although the present specification occasionally personifies the processes carried out in the steps, these processes are essentially executed by various devices. Further, the other structures necessary for the steps are obvious from the above descriptions.

What is claimed is:

1. A gaming machine configured to award, as a prize, one of plural types of progressive payouts which are different from one another in payout amount and are formed by accumulating a part of a bet amount each time a unit game is executed, the gaming machine comprising:
a display device in which symbols are rearranged on reels on which the symbols including a specific symbol are lined up; and
a controller which is configured to select one of the plural types of the progressive payouts based on processes (A) to (C),
the controller being programmed to execute the processes of:
(A) executing a normal game in which the symbols are rearranged on the display device and a prize is awarded in accordance with a combination of the rearranged symbols;
(B) when the prize awarded in the normal game is a right to award one of the plural types of the progressive payouts, randomly selecting one of the plural types of progressive payouts; and
(C) after the number of the specific symbol stored in association with the progressive payout selected in the process (B) is displayed stepwise on the display device, executing the selected progressive payout.

2. A gaming machine configured to award, as a prize, one of plural types of progressive payouts which are different from one another in payout amount and are formed by accumulating a part of a bet amount each time a unit game is executed, the gaming machine comprising:
a display device in which symbols are rearranged on reels on which the symbols including a specific symbol are lined up;
a storage configured to store: a first table in which a total number of plural types of the specific symbol rearrangeable stepwise on the display device when a winning condition of obtaining one of the plural types of progressive payouts is established is associated with each of the plural types of progressive payouts; and a second table in which, for each total number of the plural types of of the specific symbol rearrangeable stepwise on the display device when the winning condition is established, a predetermined number of allocation patterns each defining the number of the specific symbol allocated to each step are provided; and
a controller programmed to execute the processes of:
(a1) executing a normal game in which the symbols are rearranged on the display device and a prize is awarded in accordance with a combination of the rearranged symbols;
(a2) when the winning condition is established in the normal game, randomly determining the total number of the specific symbol to be rearranged stepwise on the display device;
(a3) randomly selecting one of the predetermined number of the allocation patterns associated in the second table with the total number of the specific symbol determined in the process (a2), and determining the number of the specific symbol allocated to each step;
(a4) in each step, rearranging the specific symbol on the display device, the number of the specific symbol being determined in the process (a3); and
(a5) awarding, as a prize, the progressive payout which is associated in the first table with the total number of the specific symbol determined in the process (a2).

3. The gaming machine according to claim 2, wherein,
the storage is configured to further store a third table in which, for each number of the plural types of of the specific symbol rearrangeable on the display device in each step, a predetermined number of allocation patterns each defining the number of the specific symbol allocated to each of the reels displayed on the display device are provided, and
the controller is programmed to further execute the processes of:
(b) randomly selecting, in each step, one of the predetermined number of the allocation patterns associated in the third table with the number of the specific symbol determined in the process (a3), and determining the number of the specific symbol allocated to each of the reels displayed on the display device in each step; and
in the process (a4),
rearranging the specific symbol on each of the reels displayed on the display device in each step, the number of the specific symbol being determined in the process (b).

4. The gaming machine according to claim 2, wherein,
the storage is configured to further store a fourth table which defines, for each bet amount bettable on the unit game, a selection rate at which each total number of the plural types of the specific symbol rearrangeable stepwise on the display device when the winning condition is established is selected in the process (a2),
the fourth table defines that, as the bet amount bet on the unit game increases, the selection rate of the number of the specific symbol associated in the first table with the progressive payout with a large payout increases,
the controller is programmed to further execute, in the process (a2), the process of randomly determining the total number of the specific symbol based on the selection rate of each number of the plural types of the specific symbol associated in the fourth table with the bet amount bet on the unit game.

5. The gaming machine according to claim 2, wherein,
the controller is programmed to further execute the processes of:
(c1) when a predetermined condition is established in the normal game, determining whether to award, as a prize, a right of shifting from the normal game to a special game;
(c2) when it is determined in the process (c1) that the right of shifting to the special game is awarded, executing a game of rearranging the symbols on the display device for a predetermined number of times, and awarding a prize in accordance with a combination of the symbols rearranged on the display device; and
(c3) when it is determined in the process (c1) that the right of shifting to the special game is not awarded, establishing the winning condition.
